(19) United States
(12) Patent Application Publication
(10) Pub. No.: US 2026/0335941 A1
(43) Pub. Date: Oct. 29, 2026

(54) PRESSURE-RESPONSIVE CHEMICAL DISPENSING SYSTEMS AND METHODS

(71) Applicant: Quick Quack Car Wash Holdings, LLC, Roseville, CA (US)

(72) Inventors: Kelly Jonathan Taylor, Rocklin, CA (US); Spencer Robert Drennan, Folsom, CA (US)

(73) Assignee: Quick Quack Car Wash Holdings, LLC, Roseville, CA (US)

(21) Appl. No.: 19/658,852

(22) Filed: Apr. 27, 2026

Related U.S. Application Data
(60) Provisional application No. 63/794,590, filed on Apr. 25, 2025.

(51) Int. Cl. B08B 3/02; B60S 3/04

(52) U.S. Cl. CPC B08B 3/02; B60S 3/04; B08B 2203/027

(57) ABSTRACT

A chemical dispensing system and methods of use are disclosed. The system may include a fluid supply line configured to convey a carrier fluid to a dispensing tool that is manually actuated to selectively permit fluid flow. The system further includes a chemical source storing a chemical agent, a chemical delivery device configured to introduce the chemical agent into the fluid supply line, a pressure sensor configured to measure pressure within the fluid supply line, and a controller communicatively connected to the pressure sensor and the chemical delivery device. The controller detects when pressure within the fluid supply line falls below or rises above a pressure threshold, enabling pressure-responsive chemical dispensing coordinated with manual operation of the dispensing tool.

### CROSS-REFERENCE TO RELATED APPLICATIONS

This application claims the benefit of priority of U.S. Provisional Patent Application Serial No. 63/794,590, filed on Apr.25, 2025, and titled “SYSTEMS AND METHODS FOR DISPENSING SYSTEMS,” which is incorporated by reference herein in its entirety.

### FIELD OF THE INVENTION

The present invention generally relates to the field of car wash systems. In particular, the present invention is directed to pressure-responsive chemical dispensing systems and methods.

### BACKGROUND

Manual dispensing wands are commonly used in industrial and commercial cleaning systems to apply water or chemical solutions to equipment and surfaces. In many such systems, chemical delivery is controlled through electrical triggers integrated into the dispensing tool or through continuously operating pumps that dispense chemicals regardless of whether the operator is actively spraying. These approaches can increase system complexity, require electrical components at the dispensing tool, or result in inefficient chemical usage when the system remains active while the wand is not in use. Additionally, systems that rely on manual triggering or continuous pumping may lack responsiveness to changes in fluid flow conditions within the supply line.

### SUMMARY OF THE DISCLOSURE

In some aspects, the techniques described herein relate to a chemical dispensing system, the system including a fluid supply line configured to convey a carrier fluid to a dispensing tool, the dispensing tool configured to be manually actuated to selectively permit flow of the carrier fluid through the dispensing tool, a chemical delivery device configured to deliver a chemical agent into the fluid supply line, a pressure sensor configured to measure pressure within the fluid supply line, and a controller communicatively connected to the pressure sensor and the chemical delivery device, wherein the controller is configured to: detect that the pressure within the fluid supply line has fallen below a first pressure threshold corresponding to actuation of the dispensing tool, activate the chemical delivery device in response to the pressure falling below the first pressure threshold, detect that the pressure within the fluid supply line has risen above a second pressure threshold corresponding to cessation of actuation of the dispensing tool, and deactivate the chemical delivery device in response to the pressure rising above the second pressure threshold.

In some aspects, the techniques described herein relate to a method of dispensing a chemical agent, the method including: conveying a carrier fluid through a fluid supply line to a dispensing tool, the dispensing tool being manually actuated to selectively permit flow of the carrier fluid through the dispensing tool, measuring pressure within the fluid supply line using a pressure sensor, detecting, using a controller, that the pressure within the fluid supply line has fallen below a first pressure threshold corresponding to actuation of the dispensing tool, activating, using the controller, a chemical delivery device to deliver the chemical agent into the fluid supply line in response to the pressure falling below the first pressure threshold, detecting, using the controller, that the pressure within the fluid supply line has risen above a second pressure threshold corresponding to cessation of actuation of the dispensing tool, and deactivating, using the controller, the chemical delivery device in response to the pressure rising above the second pressure threshold.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary pressure-responsive chemical dispensing system;

FIG. 2 is an exemplary embodiment of a dispensing system;

FIG. 3 is another exemplary embodiment of the dispensing system;

FIGS. 4A-4B illustrate exemplary side views of the dispensing system;

FIG. 5 illustrates yet another exemplary embodiment of the dispensing system;

FIG. 6 illustrates an exemplary embodiment of a dispensing station;

FIG. 7 illustrates yet another exemplary embodiment of the dispensing station;

FIG. 8 illustrates yet another exemplary embodiment of the dispensing system;

FIG. 9 illustrates an exemplary embodiment of a soap channel;

FIG. 10 illustrates an exemplary embodiment of an injector system;

FIG. 11 is an exemplary embodiment of a peristaltic pump;

FIG. 12 is anexemplary embodiment of a water-only dispensing system;

FIG. 13 is an exemplary embodiment of an airbox;

FIGS. 14A-14B are exemplary embodiments of the airbox;

FIGS. 15A-15B are exemplary embodiments of an injector system;

FIG. 16 is an exploded view of the injector system;

FIGS. 17A-17C illustrate exemplary embodiments of a controller;

FIGS. 18A-18B illustrate exemplary embodiments of the soap channel;

FIG. 19 is a block diagram of exemplary system for creating mixtures;

FIG. 20 is a flow diagram of an exemplary method for pressure-responsive chemical dispensing; and

FIG. 21 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Embodiments of the present disclosure relate to fluid dispensing systems configured to introduce chemical agents into a carrier fluid supplied to a manually actuated dispensing tool. In some implementations, the system monitors pressure within a fluid supply line and uses changes in the measured pressure to determine when the dispensing tool has been actuated or released. Based on these pressure conditions, a controller can selectively activate or deactivate a chemical delivery device to introduce a chemical agent into the carrier fluid. In this way, chemical dispensing can be coordinated with operation of the dispensing tool while minimizing reliance on electrical triggering mechanisms at the dispensing tool itself.

At a high level, aspects of the present disclosure are directed to systems and methods for controlling delivery of a chemical agent into a carrier fluid supplied to a manually actuated dispensing tool based on pressure conditions detected within a fluid supply line. In an embodiment, a controller monitors pressure within the fluid supply line and selectively activates or deactivates a chemical delivery device when the detected pressure crosses one or more predetermined pressure thresholds.

Aspects of the present disclosure can be used to control the introduction of chemical agents into a carrier fluid in response to operation of a manually actuated dispensing tool. Aspects of the present disclosure can also be used to coordinate chemical delivery with fluid flow conditions within a supply line without requiring electrical triggering mechanisms at the dispensing tool. This is so, at least in part, because pressure conditions within the fluid supply line provide an indication of when the dispensing tool has been actuated to permit fluid flow and when the dispensing tool has been released.

Aspects of the present disclosure allow for responsive, automated control of chemical dispensing based on pressure conditions detected within a fluid supply line. Exemplary embodiments illustrating aspects of the present disclosure are described below in the context of several specific examples.

In some cases, conventional chemical dispensing systems may rely on electrical triggers incorporated into dispensing tools or on continuously operating pumps that dispense chemicals regardless of whether the dispensing tool is actively in use. These approaches can introduce additional electrical complexity at the dispensing tool, increase maintenance requirements, or result in inefficient chemical usage when chemical delivery continues during periods of inactivity. Embodiments of the systems and methods described herein address these issues by monitoring pressure conditions within the fluid supply line and using those pressure conditions to control operation of a chemical delivery device. In this manner, advantageously, chemical dispensing can be automatically coordinated with manual operation of the dispensing tool, enabling an on-demand chemical delivery system that reduces unnecessary chemical use while avoiding the need for electrical trigger mechanisms at the dispensing tool.

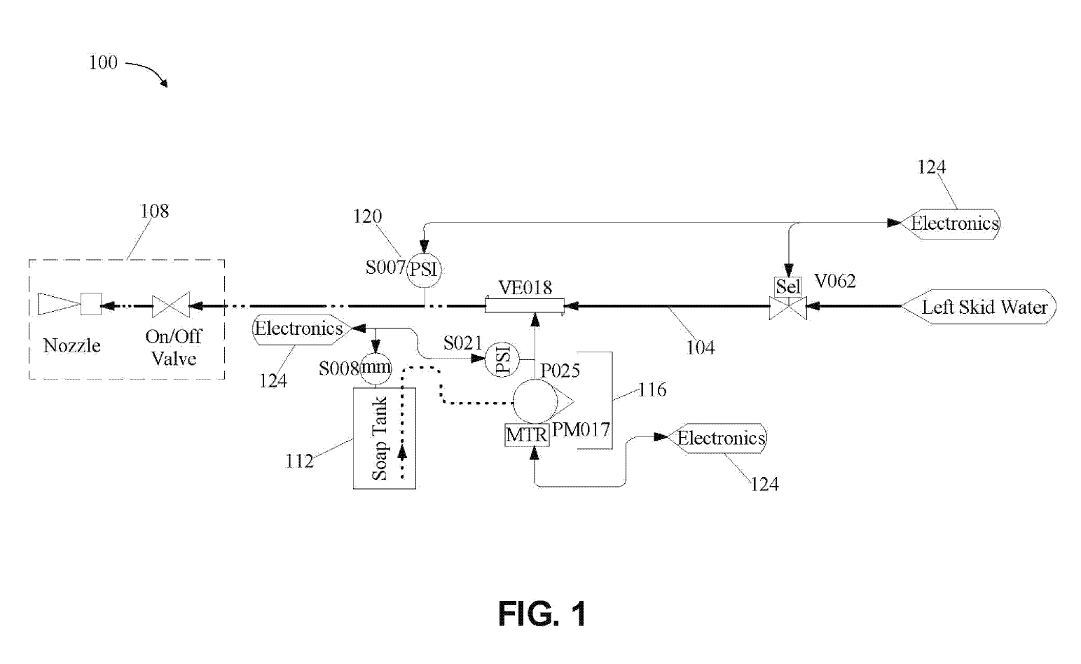

Referring now to FIG. 1, an exemplary embodiment of a chemical dispensing system 100 is illustrated. Various components of system 100 are illustrated with reference identifiers corresponding to functional elements and instrumentation within the system. For example, S008 denotes a chemical source 112, such as a soap tank configured to store a chemical agent, while S021 represents a chemical injection interface or sensor associated with introduction of the chemical agent into the fluid supply line 104. P025 and MTR/PM017 collectively represent a chemical delivery device 116, such as a pump and associated motor configured to drive delivery of the chemical agent. S007 (PS) denotes a pressure sensor 120 configured to measure pressure within the fluid supply line 104, and VE018 represents an injection element, such as a venturi injector, disposed along the fluid supply line 104. V062 identifies a valve positioned along the fluid supply line 104, and 104 represents the fluid supply line itself through which a carrier fluid (e.g., “Left Skid Water”) is conveyed. Reference 108 illustrates a dispensing tool 108, such as a spray gun including a nozzle and manually actuated valve, while 112 identifies the chemical source 112. Reference 116 corresponds to fluid or chemical delivery pathways, and 124 represents control electronics, which may collectively form or interface with a controller 124 configured to coordinate operation of the system components. FIG. 1 is an illustrative embodiment and is not intended to be limiting, as alternative configurations, component arrangements, and implementations may be employed consistent with the present disclosure.

With continued reference to FIG. 1, system 100 may include a controller 124, which may include circuitry such as without limitation a processor communicatively connected to a memory; for instance, circuitry may include and/or be included in a computing device. Memory may contain instructions configuring processor to perform any method, method steps, and/or combinations thereof as described in this disclosure. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

In continued reference to FIG. 1, in an embodiment, system 100 may include a fluid supply line 104 configured to convey a carrier fluid to a dispensing tool 108. For purposes of this disclosure, a “fluid supply line” is any conduit, channel, or pathway configured to transport a fluid between components of system 100. In an embodiment, the fluid supply line 104 may include, for example, one or more hoses, pipes, tubes, flexible lines, rigid conduits, and/or combinations thereof, and may be constructed from materials such as polymeric materials, metals, and/or reinforced composites depending on pressure and environmental requirements. In some embodiments, the fluid supply line 104 may include branching segments, junctions, fittings, and/or couplings configured to direct fluid to one or more downstream components. For purposes of this disclosure, to “convey” refers to transporting, directing, or otherwise facilitating movement of a fluid through the fluid supply line 104. Which, in various embodiments, may occur under pressure, via gravity, or through mechanical assistance such as pumps and/or valves. For purposes of this disclosure, “carrier fluid” is a base fluid used to transport or dilute a chemical agent. For example, without limitation, water, aqueous solutions, cleaning fluids, and/or other liquids suitable for mixing with a chemical agent. In some embodiments, the carrier fluid may be pressurized within the fluid supply line 104 prior to delivery to the dispensing tool 108. For purposes of this disclosure, a “dispensing tool” is a device configured to deliver the carrier fluid, with or without a chemical agent, to a target surface or environment. Non-limiting examples of dispensing tools 108 may include spray wands, spray guns, nozzles, lances, and/or other manually operable applicators that permit selective discharge of fluid. In some embodiments, the dispensing tool 108 may include a manually actuated component, such as a trigger, valve, and/or lever, configured to selectively permit or restrict fluid flow through the dispensing tool 108. In an embodiment, the dispensing tool 108 may be positioned at a location separate from one or more other components of system 100. For example, the dispensing tool 108 may be disposed within a bay accessible to vehicles, while the remaining components of system 100 are located at a different location. In such an arrangement, the fluid supply line 104 is configured to fluidly connect the other components of system 100 to the dispensing tool 108 at the secondary location.

In further reference to FIG. 1, in an embodiment, the fluid supply line 104 may receive the carrier fluid from a fluid source and convey the carrier fluid toward the dispensing tool 108 under pressure. Upon manual actuation of the dispensing tool 108, the carrier fluid may be permitted to flow through the dispensing tool 108 and discharged toward a target surface. In an embodiment, the configuration of the fluid supply line 104 and dispensing tool 108 enables controlled delivery of the carrier fluid and provides a foundation for coordinated chemical dispensing as described in further detail below.

With further reference to FIG. 1, in an embodiment, the dispensing tool 108 may be configured to be manually actuated to selectively permit flow of the carrier fluid through the dispensing tool 108. For purposes of this disclosure, “manually actuated” refers to operation initiated by direct user interaction. For example, such as the application of force by a user’s hand or body to a component of the dispensing tool 108. In some embodiments, manual actuation may be achieved through, for example, a trigger, lever, handle, push-button, squeeze mechanism, and/or valve integrated into or coupled with the dispensing tool 108. In some embodiments, manual actuation may involve transitioning the dispensing tool 108 between an open state that permits fluid flow and a closed state that restricts fluid flow, without requiring electrical input, electronic signaling, and/or powered actuation at the dispensing tool 108. For purposes of this disclosure, the term “selectively permit” refers to enabling or allowing fluid flow in a controlled and intentional manner based on the state of the dispensing tool 108, such that fluid flow is permitted when the dispensing tool 108 is actuated and restricted when the dispensing tool 108 is not actuated. In this manner, the dispensing tool 108 may function as a user-controlled flow gate that regulates discharge of the carrier fluid.

With continued reference to FIG. 1, in an embodiment, manual actuation of the dispensing tool 108 may directly influence flow conditions within the fluid supply line 104. For example, when the dispensing tool 108 is manually actuated to permit flow, the carrier fluid may be allowed to exit the dispensing tool 108, resulting in a change in pressure within the fluid supply line 104. Conversely, when manual actuation is released and flow is restricted, pressure within the fluid supply line 104 may increase. These changes in flow and pressure conditions may be used by other components of system 100, such as a controller 124 and pressure sensor 120, to coordinate operation of a chemical delivery device 116, as described in further detail below.

Still referring to FIG. 1, in an embodiment, system 100 may include a chemical source 112 configured to store a chemical agent. For purposes of this disclosure, a “chemical source” is any reservoir, container, or storage component configured to hold a chemical agent. The chemical source 112 may include, for example, tanks, bottles, cartridges, canisters, bladders, and/or other containment structures, and may be constructed from materials such as plastics, metals, or composite materials selected based on compatibility with the chemical agent. In some embodiments, the chemical source 112 may be a removable or replaceable container to facilitate refilling or interchangeability of chemical agents. In an embodiment, the chemical source 112 may further include one or more fittings, outlets, and/or interfaces configured to enable fluid communication with downstream components, such as a chemical delivery device 116. For purposes of this disclosure, a “chemical agent” is any substance configured to be introduced into the carrier fluid for application to a target surface or environment. In an embodiment, chemical agents may include, for example, cleaning solutions, detergents, disinfectants, degreasers, pesticides, fertilizers, and/or other treatment compositions. In some embodiments, the chemical agent may be provided in a concentrated form and subsequently diluted by mixing with the carrier fluid within system 100. This could include multiple lines that lead to one main line where the mixture occurs and/or there may be instances in which the carrier fluid is mixed in a reservoir prior to entering the main line, wherein the reservoir is fluidly connected to the chemical source 112 and a carrier fluid source. In a particular example, the chemical agent may include a preconditioning cleaning solution, such as a “bug wash” formulation configured to loosen or remove organic debris (e.g., insect residue) from surfaces prior to further washing or rinsing operations.

Still referring to FIG. 1, in an embodiment, the chemical source 112 may provide a supply of the chemical agent that may be selectively introduced into the carrier fluid based on system operation. In some cases, the chemical agent stored within the chemical source 112 may be delivered to a chemical delivery device 116, which may regulate the introduction of the chemical agent into the fluid supply line 104. In some implementations, the chemical source 112 may be fluidly connected to the chemical delivery device 116 through tubing or conduits, allowing controlled withdrawal of the chemical agent. In some instances, the configuration of the chemical source 112 enables storage and controlled availability of the chemical agent, supporting on-demand mixing with the carrier fluid during operation of the system as described in further detail below.

With continued reference to FIG. 1, in an embodiment, system 100 may include a chemical delivery device 116 configured to deliver the chemical agent into the fluid supply line 104. For purposes of this disclosure, a “chemical delivery device” is any component or system configured to transfer, meter, or otherwise introduce a chemical agent from a chemical source 112 into a carrier fluid flowing within the fluid supply line 104. In an embodiment, the chemical delivery device 116 may include, for example, pumps, injectors, dosing systems, metering devices, and/or combinations thereof. In some embodiments, the chemical delivery device 116 may be configured to control a rate, volume, or timing of delivery of the chemical agent based on one or more control inputs. For instance, the chemical delivery device 116 may include a pump configured to draw the chemical agent from the chemical source 112, and/or an injector configured to introduce the chemical agent into the fluid supply line 104 using pressure differentials. In other embodiments, the chemical delivery device 116 may include passive or semi-passive components, such as aspirators or eductors, that facilitate mixing of the chemical agent with the carrier fluid.

In further reference to FIG. 1, in an embodiment, the chemical delivery device 116 may be operatively connected to both the chemical source 112 and the fluid supply line 104, enabling controlled introduction of the chemical agent into the carrier fluid. Further, in some cases, the chemical delivery device 116 may be in communication with a controller 124, which may selectively activate or deactivate the device based on system conditions, such as pressure within the fluid supply line 104. For example, the controller 124 may activate the chemical delivery device 116 when a pressure drop is detected, thereby causing the chemical agent to be delivered into the fluid supply line 104 and mixed with the carrier fluid prior to discharge through the dispensing tool 108. In this manner, the chemical delivery device 116 enables on-demand delivery of the chemical agent in coordination with operation of the dispensing tool 108.

With further reference to FIG. 1, in an embodiment, the chemical delivery device 116 may include a peristaltic pump. For purposes of this disclosure, a “peristaltic pump” is a type of positive displacement pump configured to move fluid through a flexible conduit by sequential compression and relaxation of the conduit, thereby creating a traveling region of occlusion that advances fluid along the conduit. In some cases, a peristaltic pump may include, for example, a rotor assembly having one or more rollers, shoes, or cams configured to compress a flexible tube against a housing, such that rotation of the rotor causes fluid to be drawn from an inlet and discharged at an outlet without the fluid contacting internal mechanical components of the pump. In some embodiments, this configuration may reduce contamination and allow for precise metering of the chemical agent. While a peristaltic pump is one example of a suitable pump, other pump types may be used in place of or in addition to a peristaltic pump. Such pumps may include, for example, diaphragm pumps, piston pumps, gear pumps, centrifugal pumps, and/or solenoid-driven dosing pumps, each configured to transfer or meter a chemical agent from the chemical source 112 to the fluid supply line 104. Selection of a particular pump type may depend on factors such as desired flow rate, chemical compatibility, pressure conditions, and system configuration.

With continued reference to FIG. 1, in an embodiment, a peristaltic pump or other suitable pump may be configured to draw the chemical agent from the chemical source 112 and deliver the chemical agent toward a downstream injection point within the fluid supply line 104. In some embodiments, the pump may be selectively actuated by the controller 124 based on detected pressure conditions, enabling controlled and responsive delivery of the chemical agent. For example, the controller 124 may activate the pump when a pressure drop is detected in the fluid supply line 104, causing the pump to advance the chemical agent for mixing with the carrier fluid, and may deactivate the pump when pressure conditions indicate cessation of flow. In this manner, the pump may operate in coordination with system pressure dynamics to provide on-demand chemical delivery.

Still referring to FIG. 1, in an embodiment, the chemical delivery device 116 may supply the chemical agent to a venturi injector disposed along the fluid supply line 104. For purposes of this disclosure, a “venturi injector” is a device configured to introduce a secondary fluid into a primary fluid stream by utilizing a pressure differential created within a constricted region of a flow passage. In particular, a venturi injector may include a narrowed throat section through which the carrier fluid flows at an increased velocity, thereby reducing static pressure and creating a suction effect that draws the chemical agent into the fluid stream. In an embodiment, the venturi injector may include one or more inlet ports for the chemical agent and may be configured to promote mixing of the chemical agent with the carrier fluid downstream of the throat region. In some embodiments, the venturi injector may operate without moving parts, thereby providing a passive or semi-passive mechanism for introducing the chemical agent. While a venturi injector is one example of an injection mechanism, other injection or mixing components may be used in place of or in addition to a venturi injector. Such components may include, for example, eductors, aspirators, inline mixers, static mixers, dosing valves, spray injectors, and/or direct injection ports configured to introduce the chemical agent into the fluid supply line 104. In some embodiments, the chemical agent may be injected directly into the carrier fluid under pressure without reliance on a pressure differential, such as through a pressurized injection nozzle or controlled dosing valve. Selection of a particular injection mechanism may depend on factors such as desired mixing efficiency, flow rate, system pressure, and compatibility with the chemical agent.

With further reference to FIG. 1, in an embodiment, the venturi injector or alternative injection component may be disposed at various locations along the fluid supply line 104 relative to other system components. For example, the injector may be positioned upstream of the dispensing tool 108 to allow mixing prior to discharge, or at an intermediate location between the chemical delivery device 116 and the dispensing tool 108. In some configurations, the injector may be located downstream of a pump or valve, such that pressurized carrier fluid enhances the injection effect, while in other configurations the injector may be positioned upstream of certain control components. Additionally, the chemical delivery device 116 may be fluidly connected to the injector through tubing or conduits that supply the chemical agent to the injector inlet. In operation, the chemical agent delivered by the chemical delivery device 116 may be introduced into the carrier fluid at the injector location, where the fluids mix and are conveyed toward the dispensing tool 108 for application. In this manner, the injector may facilitate integration of the chemical agent into the carrier fluid stream in coordination with system operation.

In further reference to FIG. 1, in an embodiment, system 100 may include a pressure sensor 120 configured to measure pressure within the fluid supply line 104. For purposes of this disclosure, a “pressure sensor” is any device or component configured to detect, measure, or otherwise determine a pressure associated with a fluid within a conduit or system. In an embodiment, the pressure sensor 120 may include, for example, transducers, gauges, switches, and/or other sensing elements configured to generate an output signal indicative of pressure. In some embodiments, the pressure sensor 120 may include a piezoresistive sensor, strain gauge-based sensor, capacitive pressure sensor, piezoelectric sensor, and/or other suitable sensing technology. In some cases, the pressure sensor 120 may be configured to provide analog or digital signals corresponding to measured pressure values and may be in communication with a controller 124 for further processing. The term “pressure,” for purposes of this disclosure, refers to a force exerted by a fluid per unit area within the fluid supply line 104 and may be expressed in units such as pounds per square inch (PSI), pascals (Pa), or other suitable units. In some embodiments, the measured pressure may correspond to static pressure within the fluid supply line 104 when flow is restricted, or dynamic pressure conditions associated with fluid flow during operation of the dispensing tool 108.

Still referring to FIG. 1, in an embodiment, the pressure sensor 120 may provide information indicative of fluid conditions within the fluid supply line 104, which may be used to infer operation of the dispensing tool 108. For example, a decrease in measured pressure may indicate that the dispensing tool 108 has been manually actuated to permit flow of the carrier fluid, while an increase in pressure may indicate that the dispensing tool 108 has been released and flow has been restricted. In an embodiment, the pressure sensor 120 may transmit pressure data to a controller 124, which may evaluate the data relative to one or more pressure thresholds to determine whether to activate or deactivate a chemical delivery device 116. In this manner, the pressure sensor 120 may enable indirect detection of dispensing tool 108 operation and facilitate automated control of chemical delivery based on pressure conditions within the fluid supply line 104.

In further reference to FIG. 1, in an embodiment, pressure data generated by the pressure sensor 120 and communicated to the controller 124 may be further utilized for operational monitoring, timing, or maintenance functions within the system. For example, in a vehicle wash environment, pressure patterns within the fluid supply line 104 may be analyzed to determine when the dispensing tool 108 is actively in use, the duration of usage, and periods of inactivity. Such information may be used to coordinate wash cycle timing, optimize chemical application sequences, and/or ensure that preconditioning steps, such as application of a bug wash solution, occur for an appropriate duration. Additionally, deviations in expected pressure patterns may be indicative of system faults, such as blockages, leaks, and/or component wear, and may be used to trigger alerts or maintenance procedures. In this manner, pressure data may serve both as a control input for chemical delivery and as a source of diagnostic and operational insight for the overall system.

In continued reference to FIG. 1, in an embodiment, the pressure sensor 120 may be disposed along the fluid supply line 104 upstream of the dispensing tool 108. In such configurations, positioning the pressure sensor 120 upstream of the dispensing tool 108 may enable detection of pressure changes within the fluid supply line 104 that correspond to manual actuation of the dispensing tool 108. For example, when the dispensing tool 108 is actuated to permit flow, pressure within the upstream portion of the fluid supply line 104 may decrease, and when the dispensing tool 108 is released, pressure may increase, allowing the pressure sensor 120 to detect these changes and provide corresponding signals to a controller 124. In an embodiment, placement of the pressure sensor 120 upstream of the dispensing tool 108 may provide a reliable indication of flow conditions within the system without requiring integration of sensing components within the dispensing tool 108 itself. In some embodiments, the pressure sensor 120 may be positioned at various locations along the fluid supply line 104 upstream of the dispensing tool 108, including proximate to a pump, near an injection point, at an intermediate segment of the fluid supply line 104, or at a junction or manifold where fluid is distributed. In some cases, the pressure sensor 120 may be integrated inline with the fluid supply line 104 or coupled to the fluid supply line 104 through a port, fitting, or tee connection that allows the sensor to measure pressure without obstructing flow. In other embodiments, the pressure sensor 120 may not be located directly along the fluid supply line 104 but may instead be positioned at a connection point upstream, such as at an outlet of a pump, at a fluid source interface, within a valve assembly, or at a manifold supplying fluid to the fluid supply line 104. In such configurations, the pressure sensor 120 may measure pressure conditions that are representative of the pressure within the fluid supply line 104 due to fluid communication between the components.

Still referring to FIG. 1, in some embodiments, system 100 may include a plurality of pressure sensors 120 disposed at distinct locations within the system to measure pressure at multiple points along or upstream of the fluid supply line 104. In some cases, the use of multiple pressure sensors 120 may enable more precise characterization of fluid conditions within the system and may improve detection of changes associated with operation of the dispensing tool 108. For example, a first pressure sensor 120 may be positioned proximate to a fluid source or pump to measure supply-side pressure, while a second pressure sensor 120 may be disposed closer to the dispensing tool 108 to measure downstream pressure conditions. In some configurations, additional pressure sensors 120 may be positioned at intermediate locations, such as near a chemical injection point, valve assembly, and/or manifold. By comparing pressure measurements from multiple locations, the controller 124 may distinguish between different system states, such as normal flow conditions, partial flow restrictions, and/or transient pressure fluctuations. In certain embodiments, differential pressure between sensors may be used to detect conditions such as blockages, leaks, or component degradation. Additionally, multiple pressure sensors 120 may improve responsiveness and accuracy in determining when the dispensing tool 108 has been actuated or released, particularly in systems with longer fluid supply lines 104 or variable pressure conditions. In this manner, the use of multiple pressure sensors 120 may enable enhanced monitoring, control, and diagnostic capabilities within system 100.

In further reference to FIG. 1, in an embodiment, selection of the pressure sensor 120 location may depend on system design considerations such as ease of installation, accessibility, response time, and desired sensitivity to pressure changes. Regardless of the specific location, the pressure sensor 120 may be configured to detect pressure variations associated with operation of the dispensing tool 108 and provide corresponding data to the controller 124. By allowing flexibility in sensor placement, the system may accommodate a variety of plumbing configurations while still enabling pressure-based detection of dispensing tool 108 actuation and coordinated control of chemical delivery.

With continued reference to FIG. 1, in an embodiment, system 100 may include a valve disposed along the fluid supply line 104 upstream of the dispensing tool 108. For purposes of this disclosure, a “valve” is any device, component, or mechanism configured to regulate, permit, restrict, or stop the flow of a fluid within a conduit or system. In an embodiment, the valve may include, for example, solenoid valves, ball valves, gate valves, needle valves, diaphragm valves, pinch valves, or other flow-control devices capable of transitioning between different flow states. In some embodiments, the valve may be configured to operate between an open state that permits fluid flow and a closed or partially closed state that restricts or prevents fluid flow. In certain embodiments, the valve may be communicatively connected to a controller 124 and may be actively controlled based on pressure conditions detected within the fluid supply line 104. For example, a pressure sensor 120 may generate signals indicative of pressure within the fluid supply line 104, and the controller 124 may evaluate the pressure relative to one or more pressure thresholds. Based on this evaluation, the controller 124 may generate control signals to actuate the valve, thereby transitioning the valve between open and closed states. In this manner, the valve may be indirectly controlled by pressure conditions through operation of the controller 124, enabling coordinated regulation of fluid flow and pressure within the system. In other embodiments, the valve may be actuated using electrical, mechanical, pneumatic, or hydraulic mechanisms. For example, the valve may include an electrically actuated solenoid valve configured to receive control signals from the controller 124. In alternative embodiments, the valve may include pressure-responsive or mechanically biased components configured to adjust flow based on pressure conditions within the fluid supply line 104. Such variations may be implemented depending on system requirements while still enabling regulation of fluid flow within system 100.

Still referring to FIG. 1, in an embodiment, the controller 124 may receive pressure data from the pressure sensor 120 and compare the measured pressure to one or more pressure thresholds to determine an appropriate state of the valve. For example, when the pressure within the fluid supply line 104 falls below a first pressure threshold, indicating that the dispensing tool 108 has been manually actuated and fluid flow has been permitted, the controller 124 may generate a control signal to open the valve to allow carrier fluid to flow through the fluid supply line 104. Conversely, when the pressure rises above a second pressure threshold, indicating that the dispensing tool 108 is no longer actuated and fluid flow is restricted, the controller 124 may generate a control signal to close the valve to restrict or stop fluid flow. In some embodiments, the controller 124 may coordinate operation of the valve with operation of the chemical delivery device 116, such that both components are activated or deactivated in response to the same pressure-based conditions. In this manner, the system utilizes pressure conditions within the fluid supply line 104 as an indirect input for controlling both fluid flow and chemical delivery, enabling responsive, on-demand operation without requiring electrical actuation at the dispensing tool 108.

In further reference to FIG. 1, in an embodiment, the valve may be configured to open to permit the carrier fluid to flow through the fluid supply line 104 when the pressure within the fluid supply line 104 falls below the first pressure threshold. For purposes of this disclosure, a “first pressure threshold” is a predetermined pressure value or range of values used by the system as a reference point for initiating a control action in response to detected pressure conditions. In an embodiment, the first pressure threshold may be defined as a fixed value, a configurable value, or a dynamically adjusted value based on system parameters or operating conditions. For example, the first pressure threshold may be set to a value corresponding to a pressure level indicative of flow initiation within the fluid supply line 104, such as when the dispensing tool 108 has been manually actuated. In some embodiments, the first pressure threshold may be approximately 80 PSI, although other values may be used depending on system design, fluid characteristics, and desired responsiveness. For purposes of this disclosure, “approximately” refers to a value within a tolerance range that accounts for system variability, measurement accuracy, and operational conditions, and is not limited to an exact numerical value. For example, a value of approximately 80 PSI may include pressures within a range of about ±5 PSI, ±10 PSI, or another suitable tolerance depending on system design and sensor precision. In some embodiments, the first pressure threshold may fall within a range of about 60 PSI to about 100 PSI, and more specifically within a range of about 70 PSI to about 90 PSI. In other embodiments, the first pressure threshold may be selected based on operating conditions of the system, such as supply pressure, line length, and/or expected pressure drop during actuation of the dispensing tool 108. Accordingly, the first pressure threshold may be fixed, adjustable, or dynamically determined during operation to accommodate variations in system performance.

With continued reference to FIG. 1, in certain embodiments, the controller 124 may receive pressure data from the pressure sensor 120 and determine that the measured pressure has fallen below the first pressure threshold. In response, the controller 124 may generate a control signal to actuate the valve from a closed or restricted state to an open state, thereby permitting the carrier fluid to flow through the fluid supply line 104. This transition may occur when manual actuation of the dispensing tool 108 causes a reduction in pressure within the fluid supply line 104 due to fluid discharge. In this manner, the first pressure threshold serves as a trigger condition that enables system 100 to respond to changes in pressure associated with operation of the dispensing tool 108, allowing the valve to open and support fluid flow through system 100. In some implementations, the first pressure threshold may be selected to balance responsiveness and stability, such that the valve opens promptly upon detection of fluid flow while avoiding unintended actuation due to transient pressure fluctuations. The threshold may be determined based on factors such as system pressure ranges, line length, fluid viscosity, and/or desired timing of system response. In this manner, the first pressure threshold may provide a configurable parameter that governs operation of the valve in coordination with pressure conditions within the fluid supply line 104.

In continued reference to FIG. 1, in an embodiment, the valve may be configured to close to restrict flow of the carrier fluid when the pressure within the fluid supply line 104 exceeds the second pressure threshold. For purposes of this disclosure, a “second pressure threshold” refers to a predetermined pressure value or range of values used by the system as a reference point for initiating a control action associated with cessation of fluid flow or return to a standby condition. In an embodiment, the second pressure threshold may be defined as a fixed value, a configurable value, or a dynamically adjusted value based on system parameters or operating conditions. For example, the second pressure threshold may correspond to a pressure level indicative of reduced or terminated flow within the fluid supply line 104, such as when the dispensing tool 108 is no longer manually actuated. In some embodiments, the second pressure threshold may be approximately 100 PSI, although other values may be used depending on system configuration and desired responsiveness. “Approximately,” as defined previously applies similarly here. For example, a value of approximately 100 PSI may include pressures within a range of about ±5 PSI, ±10 PSI, or another suitable tolerance depending on system design and sensor precision. In some embodiments, the second pressure threshold may fall within a range of about 80 PSI to about 140 PSI, and more specifically within a range of about 90 PSI to about 120 PSI. In other embodiments, the second pressure threshold may be selected based on operating conditions such as supply pressure, system backpressure, and/or pressure recovery characteristics following actuation of the dispensing tool 108.

Still referring to FIG. 1, in certain embodiments, the controller 124 may receive pressure data from the pressure sensor 120 and determine that the measured pressure has risen above the second pressure threshold. In response, the controller 124 may generate a control signal to actuate the valve from an open state to a closed or restricted state, thereby reducing or stopping flow of the carrier fluid through the fluid supply line 104. This increase in pressure may occur when manual actuation of the dispensing tool 108 is released, causing fluid flow to cease and pressure to build within the system. In some implementations, the second pressure threshold may be selected in coordination with the first pressure threshold to define a hysteresis band, thereby preventing rapid cycling of the valve in response to minor pressure fluctuations. In this manner, the second pressure threshold may enable controlled transition of the system to a reduced-flow or standby state based on detected pressure conditions. For purposes of this disclosure, “rapid cycling” refers to repeated and frequent transitions of a system component between operational states, such as activation and deactivation, occurring over a relatively short period of time in response to minor fluctuations in an input signal. Rapid cycling may be undesirable as it can lead to increased mechanical wear, reduced system efficiency, instability in operation, and potential degradation of system components.

With continued reference to FIG. 1, in an embodiment, the first pressure threshold and the second pressure threshold may define a hysteresis band used to regulate operation of the valve and other system components. For purposes of this disclosure, a “hysteresis band” is a difference between two threshold values that creates a range of pressure within which no change in control state occurs, thereby preventing rapid or repeated switching between operational states due to minor fluctuations in measured pressure. In the context of system 100, the hysteresis band may be defined by the difference between the first pressure threshold (e.g., associated with opening of the valve and initiation of fluid flow) and the second pressure threshold (e.g., associated with closing of the valve and cessation of fluid flow). For example, the hysteresis band may span a pressure range between approximately 80 PSI and approximately 100 PSI, although other ranges may be used depending on system design. In certain embodiments, the use of a hysteresis band may improve stability and reliability of system operation by ensuring that once the valve has transitioned to an open or closed state, the system does not immediately reverse that state in response to small or transient pressure variations. For instance, after the valve opens when pressure falls below the first pressure threshold, the valve may remain open until pressure rises above the second pressure threshold, thereby avoiding oscillation of the valve near a single threshold value. In some implementations, the width of the hysteresis band may be selected based on system characteristics such as pressure variability, response time of components, and desired operational smoothness. In this manner, the hysteresis band may enable controlled and stable operation of the system by introducing separation between activation and deactivation conditions.

In further reference to FIG. 1, in an embodiment, the valve may include a solenoid valve controlled by the controller 124. For purposes of this disclosure, a “solenoid valve” is an electromechanically actuated valve that uses an electromagnetic coil to move a plunger or armature to control fluid flow through the valve. In operation, when electrical current is supplied to the solenoid coil, a magnetic field is generated that causes movement of the plunger, thereby transitioning the valve between different flow states, such as an open state that permits fluid flow or a closed state that restricts fluid flow. In an embodiment, solenoid valves may be configured as normally closed valves, which remain closed in the absence of electrical input, or normally open valves, which remain open in the absence of electrical input. In some embodiments, solenoid valves may provide rapid response times and precise control of fluid flow, making them suitable for systems requiring responsive operation based on control signals. In an embodiment, the solenoid valve may be communicatively connected to the controller 124 and configured to receive control signals generated based on pressure conditions within the fluid supply line 104. For example, when the controller 124 determines that pressure has fallen below the first pressure threshold, the controller 124 may transmit a signal to energize the solenoid valve, causing the valve to open and permit flow of the carrier fluid. Conversely, when the controller 124 determines that pressure has risen above the second pressure threshold, the controller 124 may de-energize the solenoid valve, causing the valve to close and restrict fluid flow. In some embodiments, the solenoid valve may be integrated inline with the fluid supply line 104 or may be coupled through fittings that allow it to regulate flow through the system.

With continued reference to FIG. 1, in certain implementations, the solenoid valve may operate in coordination with other system components, such as the chemical delivery device 116, such that both are controlled in response to the same pressure-based conditions. For example, the controller 124 may simultaneously actuate the solenoid valve and activate a pump when pressure falls below the first pressure threshold and may deactivate both when pressure rises above the second pressure threshold. In this manner, the solenoid valve may provide a controllable and responsive mechanism for regulating fluid flow within the system in coordination with pressure-based control logic.

Still referring to FIG. 1, in an embodiment, system 100 may include a controller 124 communicatively connected to the pressure sensor 120 and the chemical delivery device 116. For purposes of this disclosure, a “controller” is any computing device, processing unit, or control system configured to receive input signals, process data, and generate control signals to regulate operation of one or more components of system 100. In an embodiment, the controller 124 may include, for example, a microcontroller, microprocessor, programmable logic controller (PLC), embedded control unit, and/or other computing hardware capable of executing instructions. In some embodiments, the controller 124 may include memory storing instructions that, when executed, cause the controller 124 to perform operations such as evaluating pressure data relative to one or more thresholds and controlling system components accordingly. In some cases, the controller 124 may further include input/output interfaces configured to receive signals from sensors, such as the pressure sensor 120, and transmit control signals to components such as the chemical delivery device 116 and valve. In an embodiment, the controller 124 may be configured to receive pressure data from the pressure sensor 120 and determine whether the measured pressure satisfies one or more conditions, such as falling below a first pressure threshold or exceeding a second pressure threshold. Based on this determination, the controller 124 may generate control signals to activate or deactivate the chemical delivery device 116 and to actuate the valve to regulate flow within the fluid supply line 104. In some embodiments, the controller 124 may execute control logic that coordinates operation of multiple components, such as simultaneously activating a pump and opening a valve when pressure decreases and deactivating the pump and closing the valve when pressure increases. In an embodiment, the controller 124 may also be configured to implement timing functions, hysteresis-based control, and/or adaptive threshold adjustments based on system conditions.

In further reference to FIG. 1, in some implementations, the controller 124 may be integrated within a centralized control unit of a larger system, such as a vehicle wash system, or may be implemented as a distributed control component located proximate to one or more system elements. The controller 124 may communicate with system components through wired or wireless communication links, including electrical connections, communication buses, and/or network interfaces. In this manner, the controller 124 may provide centralized or distributed control over operation of system 100, enabling coordinated, pressure-based regulation of fluid flow and chemical delivery.

In continued reference to FIG. 1, in an embodiment, controller 124 may be configured to detect that the pressure within the fluid supply line 104 has fallen below a first pressure threshold corresponding to actuation of the dispensing tool 108. In certain implementations, the controller 124 may receive pressure data from the pressure sensor 120 as a continuous or discrete signal and may process the received data to determine whether a threshold condition has been satisfied. For example, the controller 124 may execute instructions that compare measured pressure values to a stored threshold value and determine when the measured pressure transitions from above the first pressure threshold to below the first pressure threshold. In some embodiments, the controller 124 may implement filtering, smoothing, or averaging techniques to reduce the impact of noise or transient fluctuations in the pressure signal prior to performing the comparison. In certain embodiments, detection of the pressure falling below the first pressure threshold may include identifying a change in pressure over time, such as a rate of decrease or a sustained drop below the threshold for a predetermined duration. In some cases, the controller 124 may also implement debounce logic or confirmation conditions to ensure that the detected pressure drop corresponds to actual actuation of the dispensing tool 108 rather than a temporary disturbance. In some implementations, the controller 124 may store historical pressure data and use such data to refine detection accuracy, adjust sensitivity, and/or adapt threshold values over time based on system performance. For example, threshold values may be dynamically updated to account for variations in supply pressure, system wear, and/or environmental conditions. In this manner, the controller 124 may employ configurable or adaptive logic to reliably detect pressure conditions associated with operation of the dispensing tool 108.

With further reference to FIG. 1, in an embodiment, controller 124 may be configured to activate the chemical delivery device 116 in response to the pressure falling below the first pressure threshold. In certain implementations, upon determining that the threshold condition has been satisfied, the controller 124 may generate a control signal configured to initiate operation of the chemical delivery device 116. For example, the controller 124 may transmit an electrical signal to energize a pump, initiate a dosing sequence, and/or otherwise enable delivery of the chemical agent into the fluid supply line 104. In some embodiments, the controller 124 may control parameters associated with operation of the chemical delivery device 116, such as flow rate, duration of operation, and/or delivery timing, based on system conditions or predefined control logic. In certain embodiments, activation of the chemical delivery device 116 may be coordinated with operation of other system components, such as a valve, such that multiple components are actuated in response to the same detected pressure condition. In an embodiment, the controller 124 may implement sequencing logic to ensure that the chemical delivery device 116 is activated at an appropriate time relative to fluid flow conditions, such as after a pressure stabilization period or after confirmation of sustained flow. In some implementations, the controller 124 may include safeguards or constraints, such as maximum runtime limits and/or conditional checks, to prevent over-delivery of the chemical agent. Additionally, the controller 124 may be configured to modify activation behavior based on stored parameters, user input, and/or system feedback, enabling customizable and adaptive operation. In this manner, the controller 124 may facilitate responsive and controlled activation of the chemical delivery device 116 based on detected pressure conditions within the fluid supply line 104.

Still referring to FIG. 1, in an embodiment, the controller 124 may be configured to detect that the pressure within the fluid supply line 104 has risen above a second pressure threshold corresponding to cessation of actuation of the dispensing tool 108. For purposes of this disclosure, the term “cessation of actuation” refers to a condition in which manual input previously applied to the dispensing tool 108 is removed or reduced such that the dispensing tool 108 transitions from a state permitting fluid flow to a state restricting or stopping fluid flow. For example, cessation of actuation may occur when a user releases a trigger, lever, or other manually actuated component of the dispensing tool 108, resulting in reduced or terminated discharge of the carrier fluid. In certain implementations, the controller 124 may receive pressure data from the pressure sensor 120 and process the data to determine whether the measured pressure has risen above the second pressure threshold. For example, the controller 124 may compare current pressure measurements to the second pressure threshold and detect a transition from below the threshold to above the threshold. In some embodiments, the controller 124 may implement filtering, smoothing, and/or averaging techniques to reduce sensitivity to noise or transient spikes in pressure. Additionally, the controller 124 may require that the pressure exceeds the second pressure threshold for a predetermined duration or satisfy a rate-of-change condition to confirm that the detected pressure increase corresponds to cessation of actuation rather than a temporary fluctuation.

With further reference to FIG. 1, in certain embodiments, the controller 124 may utilize historical pressure data, system state information, and temporal patterns to improve detection accuracy and reliability. For example, the controller 124 may maintain a rolling buffer or time-series dataset of pressure measurements and evaluate trends over time, such as pressure gradients, rate of change, or stability of pressure values following actuation events. In some implementations, the controller 124 may apply signal processing techniques, such as moving averages, low-pass filtering, or derivative analysis, to distinguish sustained pressure increases from transient spikes or noise. Additionally, the controller 124 may implement state-based logic in which transitions between operational states (e.g., active flow, idle, or transitional states) are validated based on multiple conditions, such as pressure magnitude, duration above threshold, and consistency with prior system behavior. In certain embodiments, the controller 124 may dynamically adjust the second pressure threshold based on observed system performance or environmental conditions. For example, the controller 124 may recalibrate threshold values in response to variations in supply pressure, fluid characteristics, system wear, and/or changes in line length or configuration. In some implementations, adaptive logic may include parameter tuning based on learned behavior, such as identifying typical pressure recovery profiles following cessation of actuation and adjusting detection criteria accordingly. In more advanced embodiments, the controller 124 may implement rule-based or model-based algorithms that predict expected pressure behavior and compare real-time measurements against expected profiles to detect deviations or confirm cessation of actuation. In this manner, the controller 124 may employ adaptive, data-driven logic to enhance robustness of pressure-based detection, reduce false positives or false negatives, and maintain reliable operation across a range of system conditions.

With continued reference to FIG. 1, in an embodiment, controller 124 may be configured to deactivate the chemical delivery device 116 in response to the pressure rising above the second pressure threshold. In certain implementations, upon determining that the measured pressure exceeds the second pressure threshold, the controller 124 may generate a control signal configured to cease operation of the chemical delivery device 116. For example, the controller 124 may transmit a signal to de-energize a pump, terminate a dosing sequence, and/or otherwise stop delivery of the chemical agent into the fluid supply line 104. In some embodiments, the controller 124 may control parameters associated with deactivation, such as ramp-down timing, gradual reduction of flow rate, and/or immediate cessation of operation depending on system requirements. In certain embodiments, the controller 124 may implement logic to ensure that deactivation occurs under appropriate and confirmed conditions. For example, the controller 124 may require that the pressure exceed the second pressure threshold for a predetermined duration or satisfy a stability condition before initiating deactivation, thereby reducing the likelihood of premature shutdown due to transient pressure spikes. In some implementations, the controller 124 may evaluate additional criteria, such as rate of pressure increase, consistency with prior system state, or correlation with recent activation events, to confirm that the detected condition corresponds to cessation of actuation of the dispensing tool 108.

Still referring to FIG. 1, in certain embodiments, the controller 124 may utilize adaptive and data-driven logic to refine deactivation behavior over time. For example, the controller 124 may analyze historical pressure recovery patterns to determine expected system response following release of the dispensing tool 108 and may adjust deactivation timing or threshold conditions accordingly. In some cases, the controller 124 may also implement predictive or model-based approaches to anticipate when pressure conditions are likely to exceed the second pressure threshold and proactively prepare for deactivation of the chemical delivery device 116. In some embodiments, the controller 124 may incorporate safeguards, such as maximum run-time limits, chemical usage thresholds, and/or fault detection logic, to ensure that the chemical delivery device 116 is reliably deactivated under both normal and abnormal conditions.

With continued reference to FIG. 1, in some implementations, deactivation of the chemical delivery device 116 may be coordinated with operation of other system components, such as closing a valve or transitioning the system to a standby pressure state. For example, the controller 124 may simultaneously deactivate the chemical delivery device 116 and actuate a valve to restrict fluid flow when the pressure exceeds the second pressure threshold. In this manner, the controller 124 may provide coordinated and responsive control over system components, enabling efficient and controlled termination of chemical delivery based on pressure conditions within the fluid supply line 104.

In further reference to FIG. 1, in an embodiment, controller 124 may be configured to maintain a standby pressure within the fluid supply line 104 when the dispensing tool 108 is not manually actuated by selectively actuating a valve disposed along the fluid supply line 104 to maintain the pressure at or above the first pressure threshold. For purposes of this disclosure, “standby pressure” is a maintained pressure level within the fluid supply line 104 during periods in which the dispensing tool 108 is not actively permitting fluid flow, such that the system remains in a ready state for subsequent actuation. In an embodiment, the standby pressure may correspond to a pressure level sufficient to enable rapid initiation of fluid flow and chemical delivery upon actuation of the dispensing tool 108, while avoiding unnecessary continuous flow through the system. In certain embodiments, the controller 124 may receive pressure data from the pressure sensor 120 and determine whether the measured pressure falls below a desired standby level, such as the first pressure threshold or another predefined value. In response to detecting that the pressure has decreased below the standby pressure level, the controller 124 may generate control signals to actuate the valve in a manner that permits limited flow of the carrier fluid into the fluid supply line 104, thereby increasing pressure toward the desired standby level. For example, the controller 124 may intermittently open and close the valve, modulate the degree of valve opening, and/or otherwise regulate flow to maintain pressure within a target range. In some implementations, the controller 124 may apply feedback control techniques, such as proportional, integral, and/or derivative (PID) control, to adjust valve actuation based on deviations from the desired standby pressure.

With further reference to FIG. 1, in some embodiments, the valve used to maintain standby pressure may be the same valve previously described as being controlled in response to pressure threshold conditions. In such configurations, the controller 124 may operate the valve in multiple modes, including a standby pressure maintenance mode and an active flow mode associated with dispensing tool 108 actuation. In other embodiments, the valve used for maintaining standby pressure may be distinct from the valve used for controlling flow in response to pressure thresholds. For example, a first valve may be dedicated to regulating standby pressure, while a second valve may be configured to control primary fluid flow during operation of the dispensing tool 108. The selection of a single valve or multiple valves may depend on system design considerations such as complexity, responsiveness, and desired control granularity.

In continued reference to FIG. 1, in certain implementations, maintaining standby pressure may improve system responsiveness by reducing the time required to achieve desired flow conditions when the dispensing tool 108 is actuated. Additionally, maintaining standby pressure may enable more consistent operation of the chemical delivery device 116 and associated injection components. In this manner, the controller 124 may enable dynamic regulation of pressure within the fluid supply line 104 during idle conditions, ensuring that the system remains prepared for on-demand operation while minimizing unnecessary fluid flow.

With further reference to FIG. 1, in an embodiment, controller 124 may be configured to activate the chemical delivery device 116 after the pressure within the fluid supply line 104 rises to or above the first pressure threshold following manual actuation of the dispensing tool 108. In certain implementations, rather than initiating activation immediately upon detection of a pressure drop, the controller 124 may monitor pressure recovery within the fluid supply line 104 and delay activation of the chemical delivery device 116 until the pressure reaches or exceeds the first pressure threshold. This approach may ensure that sufficient flow conditions are established within the fluid supply line 104 prior to introduction of the chemical agent. In some embodiments, the controller 124 may implement sequencing logic that includes detecting an initial pressure drop associated with actuation of the dispensing tool 108, followed by confirmation that pressure has stabilized or recovered to a target level before activating the chemical delivery device 116. In an embodiment, the controller 124 may evaluate factors such as rate of pressure increase, duration of pressure stabilization, or consistency of pressure measurements to determine when activation should occur. In certain implementations, this delayed activation may reduce variability in chemical mixing, improve dosing accuracy, and prevent introduction of the chemical agent during transient or unstable flow conditions. In certain embodiments, the controller 124 may dynamically adjust the timing of activation based on system conditions, such as supply pressure, fluid characteristics, and/or prior operational patterns. For example, the controller 124 may learn or estimate a typical pressure recovery profile and use this information to optimize activation timing. In this manner, the controller 124 may provide controlled and coordinated activation of the chemical delivery device 116 based on both pressure drop and subsequent pressure recovery conditions within the fluid supply line 104.

With continued reference to FIG. 1, in an embodiment, the chemical dispensing system may further include a specialized configuration for the delivery of a preconditioning cleaning solution, such as a “bug wash” or “bug juice” system. This configuration may utilize a standard dilution channel architecture that monitors the output pressure and coordinates the operation of a valve and a chemical delivery device. To ensure the system is continuously responsive, a booster pump or similar pressurized source may remain active at all times, while the controller selectively opens a valve, such as a modulating ball valve, to maintain a specific target standby pressure within the fluid supply line and associated hose. This maintained pressure ensures that the system remains in a ready state, prepared to deliver the chemical agent immediately upon user demand. In one or more embodiments, the system operates as an automatically responding unit that interfaces with a manually actuated dispensing tool, such as a spray gun configured for the application of bug pre-treatment. Because the system relies on internal pressure dynamics, it eliminates the need for electrical components or triggering mechanisms at the spray tool itself. When an operator actuates the spray gun, the sudden release of fluid causes the pressure within the supply line to drop below a first pressure threshold. The controller detects this drop and responds by opening the valve and/or activating the pump to meter the chemical agent into the carrier fluid. This mixture is then navigated downstream through the pressurized supply line to be expelled through the bug spray gun at high pressure. In one or more embodiments, the regulation of pressure and fluid flow is achieved through the use of an automated valve, such as a motorized ball valve or a proportional control valve. Unlike a simple on/off solenoid, a motorized ball valve can rotate to various positions to precisely modulate the flow aperture based on digital or analog signals from the controller. For instance, while a primary pump or booster remains on at all times to provide consistent supply-side energy, the valve acts as the primary regulator for the downstream line. When the bug spray gun is opened and the pressure sensor detects a drop in pressure, the controller commands the valve to rotate or open further to compensate for the flow demand and stabilize the operating pressure. When the operator releases the trigger to cease spraying, the flow is restricted, causing the pressure within the fluid supply line to jump or rise rapidly. The system continues to pressurize the line until it exceeds a second pressure threshold, at which point the controller automatically commands the motorized valve to close or restrict the flow. This automatic cycle ensures that the system only consumes chemicals and energy during active use while maintaining a consistent standby pressure for subsequent operations. By utilizing the rotating movement of a ball valve to adjust for real-time pressure transitions, the system may ensure that pressure is constant.

The following description provides additional context regarding exemplary fluid dispensing architectures and components that may be incorporated into or used in conjunction with the systems and methods described herein. In particular, certain embodiments described below illustrate generalized dispensing system configurations, including components for fluid distribution, chemical delivery, sensing, and control. These descriptions are provided to demonstrate example implementations and supporting infrastructure that may be utilized in connection with pressure-responsive chemical dispensing systems, such as those described in the present disclosure. It should be understood that the specific configurations, components, and operational details described below are exemplary in nature and may be modified, substituted, or omitted without departing from the scope of the present disclosure.

Further, the methods, processes, and/or hardware described herein, including variations, substitutions, or alternative implementations thereof, may be consistent with and may incorporate aspects of the systems, methods, and components described in U.S. Patent Application No. XX/XXX,XXX (Attorney Docket No. 1469-074USU1), filed on XX/XX/XXXX, and entitled “DISPENSING SYSTEMS AND METHODS OF USE,” U.S. Patent Application No. XX/XXX,XXX (Attorney Docket No. 1469-074USU2), filed on XX/XX/XXXX, and entitled “APPARATUS FOR AND METHODS OF MIXING AND DELIVERING A DILUTED CHEMICAL SOLUTION,” and U.S. Patent Application No. XX/XXX,XXX (Attorney Docket No. 1469-074USU3), filed on XX/XX/XXXX, and entitled “APPARATUS FOR AND METHOD OF GENERATING AN OUTPUT,” each of which is incorporated herein by reference, in their entirety.

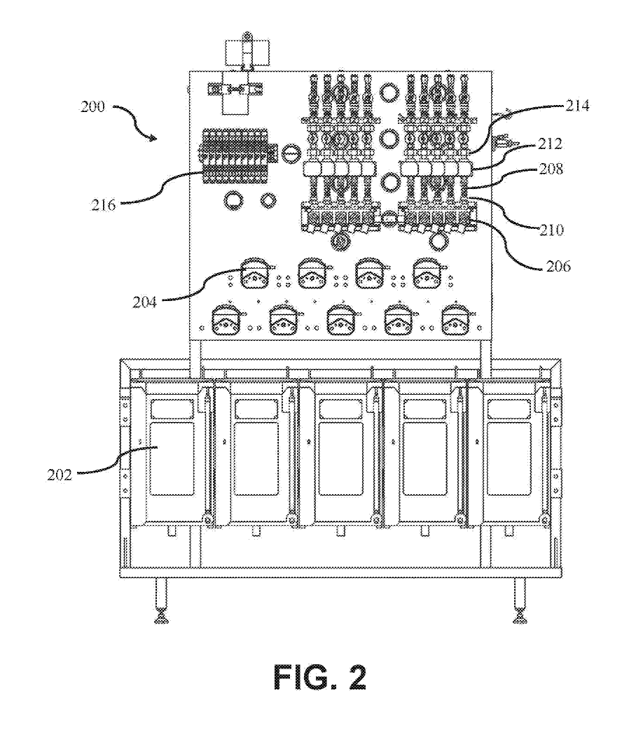

Referring now to FIG. 2, an exemplary embodiment of a dispensing system 200 is described. In one or more embodiments, dispensing system 200 may be configured to dispense a fluid. In one or more embodiments, dispensing system 200 may be configured to control dilution rates of an active agent such as soap. In one or more embodiments, dispensing system 200 may control dilution rates by means of controlling active agent flow rates and dilutant flow rates. In one or more embodiments, dispensing system 200 may further be configured to create a foam by controlling air intake into a mixture of soap and water and/or an active agent and fluid. In one or more embodiments, dispensing system 200 may further be configured to create a foam through air injection, wherein air may be pushed into the liquid stream. In one or more embodiments, dispensing system 200 may be configured to dispense a mixture containing fluid and an active agent. An “active agent” as described in this disclosure refers to chemical and/or combination of chemicals that is ultimately used to clean a device or product. For example, and without limitations, active agents may include chemicals used to clean, or apply the aforementioned solid or liquid film to, a car tire, and/or the like. In one or more embodiments, active agents may include water-soluble substances used to create a solid or liquid film on the surface of the device or product being cleaned for the purpose of enhancing hydrophobicity, shine, repulsion of particulates, or effectiveness of rinsing of other active agents. In one or more embodiments, an active agent may include a soap, a cleaning agent and/or any other combinations of fluids and/or solvents. In one or more embodiments, dispensing system 200 may be configured to mix an active agent, such as soap, and a fluid, such as water to create a mixture. In one or more embodiments, dispensing system 200 may include one or more storage tanks 202. In one or more embodiments, an active agent may be applied to a car wash system and/or to a device, such as vehicle without dilution with fluid. In one or more embodiments, dispensing system 200 may be configured to control flow rate of active agent into system. In one or more embodiments, storage tanks 202 may be configured to store one or more active agents. In one or more embodiments, each storage tank 202 of a plurality of storage tanks may be configured to house and/or store a separate active agent, such as for example, a soap for a differing purposes. In one or more embodiments, storage tanks 202 may include sensors, such as but not limited to, proximity sensors, ultrasonic sensors, pressure sensors and/or the like to sense an amount of active agent within each storage tank 202. In one or more embodiments, storage tanks 202 may include any storage tanks as described in this disclosure. In one or more embodiments, storage tanks may include level sensors, ultrasonic sensos, radar sensors, pressure differential sensor and/or the like,

With continued reference to FIG. 1, dispensing system 200 may include one or more peristaltic pumps 204. A peristaltic pump, also known as a hose or tube pump, is a type of positive displacement pump that moves fluids through a flexible tube using a rotating mechanism. The core working principle involves compressing and releasing the tube in a sequential manner to create a vacuum effect that draws fluid into the tubing and pushes it forward. This may be achieved by rollers or shoes mounted on a rotating rotor that press against the tubing, pinching it closed at multiple points. As the rotor turns, the pinched section moves along the tube, pushing the liquid ahead while drawing more liquid in behind it. Since the fluid only contacts the inner surface of the tubing, this pump design is especially suited for sterile, corrosive, or abrasive fluids, making it popular in medical, pharmaceutical, food processing, and chemical industries. It is also highly valued for its ability to handle shear-sensitive materials gently, its self-priming capability, and its ability to run dry without damage. Maintenance is straightforward, typically involving only tube replacement, since the tubing is the primary wear component. Additionally, flow rate can be easily adjusted by changing the rotor speed or tube diameter, giving the peristaltic pump flexibility across a wide range of applications. In one or more embodiments, a different style of positive displacement pump might be used in lieu of peristaltic pump, such as but not limited to, a vane pump, a gear pump, a gerotor pump, Roots-type pump, a rotary motor or solenoid-driven diaphragm pump, a piston pump, or a progressive cavity pump. A non-positive displacement pump could also be used if its flow rate is monitored by a flow measurement system such as an orifice and differential pressure sensor, an ultrasonic flow sensor, a thermal mass flow sensor, a positive displacement flow sensor (e.g., microgear), a turbine flow sensor, or an electromagnetic flow sensor. In one or more embodiments, any positive displacement pump may be used to pump active agent through system. In one or more embodiments, peristaltic pump may be used to measure a flow rate of active agent within dispensing system 200.

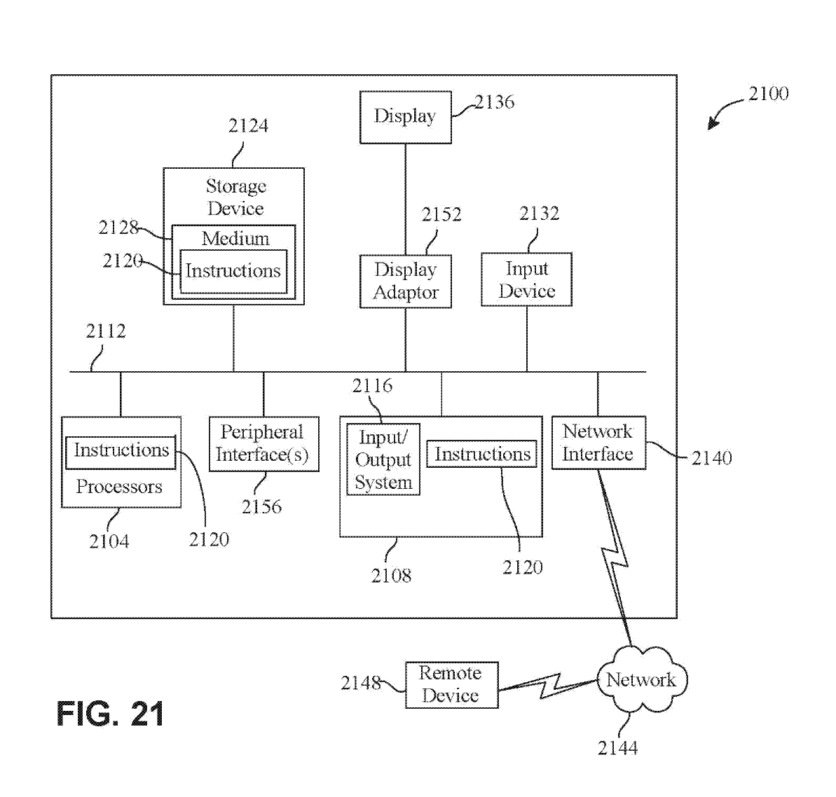

With continued reference to FIG. 2, each storage tank 202 may include a peristaltic pump 204 configured to move and/or pump active agent or soap from storage tanks. In one or more embodiments, peristaltic pump 204 may be used to monitor precise flow of an active agent such as soap. In one or more embodiments, peristaltic pump 204 may be activated and/or controlled using pressure and/or flow sensors. In one or more embodiments, each storage tank 202 may be fluidly connected to a peristaltic pump 204, such that active agents, such as soap within storage tank are pumped and/or extracted using peristaltic pumps 204. In one or more embodiments, peristaltic pump 204 may include gear pumps configured to high pressure and high precision flow. In one or more embodiments, each storage tank may contain level sensors configured to sense an active agent within each storage tank 202. In one or more embodiments, level sensors may identify the presence of active agent and thus the amount of active agent remaining within each storage tank 202. In one or more embodiments, level sensors may be used to determine when a storage tank 202 has been depleted of active agent and thus requires additional active agent. In one or more embodiments, level sensors may further be used to identify degradation within the piping of dispensing system 200. In one or more embodiments, a controller, such as any controller as described in this disclosure may identify a flow rate of active agent exiting storage tank 202 and thus identify a flow rate of active agent entering soap channel. In one or more embodiments, flow rates identified by level sensor and flow rate identified by other sensors may be used to determine component degradation, pipe degradation and/or the like. This is described in further detail below, such as in reference to at least FIG. 21.

With continued reference to FIG. 2, dispensing system 200 may include one or more water solenoids 206. A water solenoid is a component used to distribute water (or water-based mixtures) from a single input source to multiple output lines or dispensing points. The water solenoid may serve as a centralized control and distribution block, allowing water or mixtures to be directed accurately and efficiently to different destinations, such as dispensing nozzles, mixing tanks, or processing equipment. In one or more embodiments, water solenoids 206 may be made from stainless steel, plastic, or other corrosion-resistant materials. In one or more embodiments, water solenoids 206 may include valves, flow meters, pressure gauges, sensors for real-time monitoring and precise control over a flowrate and composition. In one or more embodiments, water solenoids 206 may include valves that allow for a fluid, such as water to enter dispensing system 200. In one or more embodiments, water solenoids may include electrical, pneumatic and/or any other sort of valves that control the flow of a fluid. In one or more embodiments, water solenoids may include actuators that control the flow of a fluid, such as water.

With continued reference to FIG. 2, water solenoid may include one or more valves used to control the flow of a fluid such as water. As nonlimiting examples, valve may include directional valves, control valves, selector valves, multi-port valves, check valves, and the like. Valves may include any suitable valve construction including ball valves, butterfly valves, needle valves, globe valves, gate valves, wafer valves, regulator valves, and the like. Valves may be included in a manifold of hydraulic or pneumatic circuit, for example allowing for multiple ports and flow paths. Valves may be actuated by any known method, such as without limitation by way of hydraulic, pneumatic, mechanical, or electrical energy. For instance, in some cases, valve may be actuated by an energized solenoid or electric motor, as described above. Valve actuators and thereby valves themselves may be controlled by computing device. Computing device and/or control unit may be in communication with valve, for example by way of one or more of electrical communication, hydraulic communication, pneumatic communication, mechanical communication, and the like. A person of ordinary skill in the art, upon reviewing the entirety of this disclosure, will be able to recognize how devices such as flow rate sensors and valves may be implemented within dispensing system 200.

For the purposes of this disclosure, an “actuator” is a device or a component of a machine that produces force, torque, or displacement, usually in a controlled manner, when an electrical, pneumatic, or hydraulic input is supplied to it in an actuating system and converted into a required form of mechanical energy. Actuator may, in some cases, require a control signal and/or a source of energy or power, as described below in this disclosure. In some cases, control signal may be relatively low energy. Exemplary control signal forms include electric potential or current, pneumatic pressure or flow, hydraulic fluid pressure or flow, mechanical force/torque or velocity, or even human power. In some cases, actuator may have source of energy or power other than control signal. This may include a main energy source, which may include for example electric power, hydraulic power, pneumatic power, mechanical power, and/or the like. In some cases, upon receiving control signal, actuator may respond by converting source power into mechanical motion. In some cases, actuator may be understood as a form of automation or automatic control.

With continued reference to FIG. 2, in one or more embodiments, actuator may include a hydraulic actuator. Hydraulic actuator may consist of a cylinder or fluid motor that uses hydraulic power to facilitate mechanical operation. Output of hydraulic actuator may include mechanical motion, such as without limitation linear, rotatory, or oscillatory motion. In some cases, hydraulic actuator may employ a liquid hydraulic fluid. As liquids, in some cases, are incompressible, hydraulic actuators may be capable of exerting large forces. Additionally, as force is equal to pressure multiplied by area, hydraulic actuators may act as force transformers with changes in area (e.g., cross-sectional area of a cylinder and/or piston). An exemplary hydraulic cylinder may consist of a hollow cylindrical tube within which piston can slide. In some cases, hydraulic cylinder may be considered single acting. A single-acting piston may be used when fluid pressure is applied substantially to just one side of the piston. Consequently, single-acting piston may move in only one direction. In some cases, a spring may be used to give single-acting piston a return stroke. In some cases, hydraulic cylinder may be double acting. A double-acting piston may be used when pressure is applied substantially on each side of the piston; any difference in resultant force between the two sides of piston may cause the piston to move.

With continued reference to FIG. 2, in one or more embodiments, actuator may include a pneumatic actuator. In some cases, pneumatic actuators may enable considerable forces to be produced from relatively small changes in gas pressure. In some cases, pneumatic actuators may respond more quickly than other types of actuators, for example hydraulic actuators. Pneumatic actuators may use compressible fluid. In some cases, pneumatic actuators may operate on compressed air. Operation of hydraulic and/or pneumatic actuators may include control of one or more valves, circuits, fluid pumps, and/or fluid manifolds.

With continued reference to FIG. 2, in some cases, actuator may include an electric actuator. Electric actuator may include any electromechanical actuators, linear motors, and the like. Electromechanical actuators may convert a rotational force of an electric rotary motor into a linear movement to generate a linear motion through a mechanism. Exemplary mechanisms include rotational-to-translational motion transformers, such as without limitation a belt, a screw, a crank, a cam, a linkage, a scotch yoke, and the like. In some cases, control of electromechanical actuator may include control of electric motor; for instance, control signal may control one or more electric motor parameters to control the electromechanical actuator. Nonlimiting examples of electric motor parameters include rotational position, input torque, velocity, current, and potential. Electric actuator may include a linear motor. Linear motors may differ from electromechanical actuators, as power from linear motors is output directly as translational motion, rather than output as rotational motion and converted to translational motion. In some cases, linear motor may cause less friction loss than other devices. Linear motors may be further specified into at least three different categories, including flat linear motor, U-channel linear motors and tubular linear motors. Linear motors may be directly controlled by control signal for controlling one or more linear motor parameters. Nonlimiting examples of linear motor parameters include position, force, velocity, potential, and current. In some cases, electric actuator may include a solenoid actuator. For the purposes of this disclosure, a “solenoid” is a device capable of converting electrical energy into mechanical work; it comprises a coil of wire, a housing, and a movable plunger; when an electrical current is introduced, a magnetic field forms around the coil which moves the plunger.

With continued reference to FIG. 2, in one or more embodiments, actuator may include a mechanical actuator. In some cases, mechanical actuator may function to execute movement by converting one kind of motion, such as rotary motion, into another kind, such as linear motion. An exemplary mechanical actuator includes without limitation a rack and pinion. In some cases, a mechanical power source, such as a power take-off, may serve as a power source for mechanical actuator. Mechanical actuators may employ any number of mechanisms, including for example without limitation gears, rails, pulleys, cables, linkages, and the like.

With continued reference to FIG. 2, dispensing system 200 may include a plurality of water solenoids 206, wherein each water solenoid may be configured for a separate storage tank 202 containing a separate active agent. In one or more embodiments, each storage tank 202 may be assigned a separate water solenoid which is used to mix active agent with a fluid within water solenoid. In one or more embodiments, each storage tank 202 may be assigned more than one water solenoids for redundancy.

With continued reference to FIG. 2, each water solenoid 206 may be connected to a central fluid line, such as a central water line that provides fluids to dispensing system 200. In one or more embodiments, each water solenoid may provide fluid to a designated channel 208. In one or more embodiments, designated channel 208 may include piping and/or a means to transfer fluid from water solenoid through dispensing system 200. In one or embodiments, designated channel may include tubular piping made of aluminum, steel, plastic and/or the like and be configured to route fluid from water manifold through dispensing system. In one or more embodiments, each water solenoid may be fluidly connected to designated channel. In one or more embodiments, each designated channel 208 may include a sensor, such as a pressure sensor and/or flow meter configured to identify a pressure or flow of from each water solenoid. in one or more embodiments, dispensing system 200 may further include a flow rate sensor. For the purposes of this disclosure, a “flow rate sensor” is a device installed adjacent to a stream of liquid and configured to measure its real-time flow rate, i.e., the amount or volume of fluid that passes through per unit time, in gallons per minute, liters per minute, milliliters per minute, gallons per second, liters per second, milliliters per second, or another unit similar thereto. As a nonlimiting example, when liquid flow is steady, i.e., with a constant or nearly constant flow rate, duration of liquid flow may be calculated by dividing the amount/volume of liquid by the flow rate. In one or more embodiments, dispensing system 200 may include a pressure sensor 210 at or near water solenoid 206 in order to identify a pressure of fluid from water solenoid and in designated channel. In one or more embodiments, pressure sensor 210 may be used to ensure pressure isn’t starved.

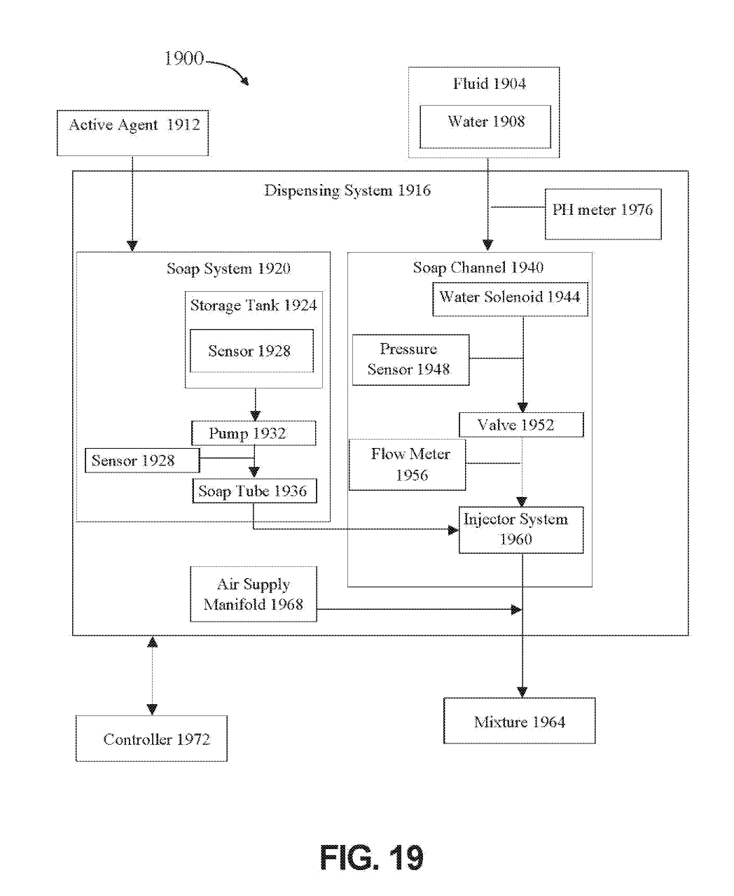

With continued reference to FIG. 2, dispensing system 200 further includes a valve 212. Valve may include any valve as described in this disclosure. In one or more embodiments, valve 212 may include a motorized ball valve. In one or more embodiments, valve may be used to control a flow of fluid from water solenoid and through designated channel 208. In one or more embodiments, pressure sensor 210 may be located between valve 212 and water solenoid 206 to identify a pressure of a fluid within channel 208. In one or more embodiments, water solenoid may provide fluid from one end of designated channel 208, wherein valve 212 may control a flow of fluid through designated channel. In one or more embodiments, valve 212 may include a motorized ball valve to adjust flow rate. In one or more embodiments, each designated channel 208 and/or water solenoid may include a valve 212 configured to control a flow rate of a fluid such as water. In one or more embodiments, valve 212 may include a motorized ball valve. A motorized ball valve is an automated valves that use an electric motor to operate the ball inside the valve, allowing precise control of fluid flow in a piping system. In one or more embodiments, motorized ball valve, may include an on/off motorized ball valve, modulating motorized ball valves, multi-port motorized ball valves, fail-safe motorized all valves and/or the like. In one or more embodiments, valve 212 may include any proportional control valve, i.e. a valve whose flow aperture increases and decreases over a defined range via a digital or analog modulation signal operated by computing devices, analog control signal sources, or other devices in a feedback loop. This valve could also be the sole means of activating water flow, eliminating the need for a solenoid valve as the on/off water supply valve for a given dilution channel. In one or more embodiments, valve 212 may be configured to adapt to varying flow rates. In one or more embodiments, a controller such as any controller as described in this disclosure may be configured to actuate and/or manipulate valve 212 in order to control a flow of fluid though soap channel. In one or more embodiments, controller may be configured to transmit command signals to valve 212 in order to increase or decrease a flow rate of fluid navigating through soap channel. In one or more embodiments, a controller, such as any controller as described in this disclosure may use sensors such as level sensors, pressure sensors, flow meters and/or the like to identify a flow rate of fluid and/or active agent and adjust the flow rate of fluid to ensure proper dilution ratios between active agent and fluid. This is described in further detail below, such as in reference to at least FIG. 19.

With continued reference to FIG. 2, in one or more embodiments, dispensing system may include one or more flow meters 214. In one or more embodiments, flow meters 214 may allow for identification of a flow rate of fluid within designated channel 208 after navigation through valve 212. In one or more embodiments, flow meter 214 may be used to identify an amount of fluid that is allowed to pass through ball valve. In one or more embodiments, flow meter 214 may be used to control valve 212, such that flow meter 214 may identify an amount of fluid flowing, and a controller as described in detail below, may be used to control a flow rate of valve 212. This will be described in further detail below. In one or more embodiments, flow meter 214 may include any flow meter as described in this disclosure and/or any sensor used to monitor flow of a fluid.

In one or more embodiments, dispensing system 200 may include and/or be fluidly connected to airbox An “Airbox” as described in this disclosure is a component configured to provide air to dispensing system. In one or more embodiments, airbox may provide air to dispensing system 100 such that air is injected into a mixture created by dispensing system. In one or more embodiments, Overall air pressure per application may be regulated by dispensing system 200. The air pressure set on dispensing system 100 should match what the pressure gauge is reading on the Airbox. The gauge in Airbox is after the airbox’s regulator and will indicate the output pressure of the secondary regulator present in the air boxes for each unique soap application. The regulator should be fully open (turned fully counterclockwise), and the needle valve should be used to adjust outgoing air. Each applicator contains its own needle valve to adjust its individual outgoing air – which will adjust foaminess at that applicator. Overall outgoing air pressure settings and needle valve settings should match the standard settings highlighted on the table below. Additional components of dispensing system 200 will be described in further detail below.

With continued reference to FIG. 2, dispensing system 200 may include an air supply manifold 216 with solenoid valves. The air supply manifold 216 is designed and/or configured to manage and distribute compressed air for soap application within dispensing system 200. In the direction of airflow, the system begins with a pressure regulator, which ensures that the air pressure is reduced and maintained at a consistent, pre-set level suitable for the downstream components. Immediately following the regulator is an output pressure gauge and sensor, which continuously monitor and display the regulated air pressure, providing real-time feedback for system diagnostics or automation control. Next, the air flows into a distribution manifold, which serves as a hub to evenly route the regulated air to multiple outputs. These outputs are each connected to solenoid valves, with one valve dedicated to each soap application line. The solenoid valves control the on/off flow of air to their respective applicators, enabling precise control over soap dispensing operations.

With continued reference to FIG. 2, dispensing system 200 may include one or more sensors, such as for example, pressure sensor, flow meter, level sensor and/or the like. Sensor may include one or more sensors. As used in this disclosure, a “sensor” is a device that is configured to detect an input and/or a phenomenon and transmit information related to the detection. For example, and without limitation, a sensor may transduce a detected charging phenomenon and/or characteristic, such as, and without limitation, temperature, voltage, current, pressure, and the like, into a sensed signal such as a voltage with respect to a reference. Sensor may detect a plurality of data. A plurality of data detected by sensor may include, but is not limited to pressure, temperature, carbon saturation, oxygen saturation and/or the like. In one or more embodiments, and without limitation, sensor may include a plurality of sensors. In one or more embodiments, and without limitation, sensor may include an optical or image sensor such as a camera, a CMOS detector, a CCD detector, a video camera, a photodiode, a photovoltaic cell, a photoconductive device, a thermal and/or infrared camera, one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, and the like. Sensor may be a contact or a non-contact sensor. Signals may include electrical, electromagnetic, visual, audio, radio waves, or another undisclosed signal type alone or in combination.

With continued reference to FIG. 2, sensor may include a plurality of independent sensors, where any number of the described sensors may be used to detect any number of physical or thermal qualities associated with carbon capture chamber 216a-n. Independent sensors may include separate sensors measuring physical or thermal quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of sensor to detect phenomenon may be maintained.

With continued reference to FIG. 2, sensor may include a pressure sensor. A “pressure,” for the purposes of this disclosure, and as would be appreciated by someone of ordinary skill in the art, is a measure of force required to stop a fluid from expanding and is usually stated in terms of force per unit area. In non-limiting exemplary embodiments, a pressure sensor may be configured to measure an atmospheric pressure and/or a change of atmospheric pressure. In some embodiments, a pressure sensor may include an absolute pressure sensor, a gauge pressure sensor, a vacuum pressure sensor, a differential pressure sensor, a sealed pressure sensor, and/or other unknown pressure sensors or alone or in a combination thereof. The pressor sensor may include a barometer. In some embodiments, the pressure sensor may be used to indirectly measure fluid flow, speed, water level, and altitude. In some embodiments, a pressure sensor may be configured to transform a pressure into an analogue electrical signal. In some embodiments, the pressure sensor may be configured to transform a pressure into a digital signal.

With continued reference to FIG. 2, sensor may include a moisture sensor. “Moisture,” as used in this disclosure, is the presence of water, which may include vaporized water in air, condensation on the surfaces of objects, or concentrations of liquid water. Moisture may include humidity. “Humidity,” as used in this disclosure, is the property of a gaseous medium (almost always air) to hold water in the form of vapor. In an embodiment, a moisture sensor may include a hygrometer. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity,” for the purposes of this disclosure, is expressed as a percentage, indicating a present stat of absolute humidity relative to a maximum humidity given the same temperature. “Specific humidity,” for the purposes of this disclosure, is the ratio of water vapor mass to total moist air parcel mass, where parcel is a given portion of a gaseous medium. Humidity sensor may be psychrometer. Humidity sensor may be a hygrometer. Humidity sensor may be configured to act as or include a humidistat. A “humidistat,” for the purposes of this disclosure, is a humidity-triggered switch, often used to control another electronic device. Humidity sensor may use capacitance to measure relative humidity and include in itself, or as an external component, include a device to convert relative humidity measurements to absolute humidity measurements.

With continued reference to FIG. 2, sensor may include a moisture sensor. In one or more embodiments, dispensing system 200 may include moisture sensor configured to measure moisture datum .

With continued reference to FIG. 2, sensor may include thermocouples, thermistors, thermometers, infrared sensors, resistance temperature detectors (RTDs), semiconductor based integrated circuits (ICs), a combination thereof, or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor, may be measured in Fahrenheit (ºF), Celsius (ºC), kelvin (K), Rankine (ºR), or another scale alone or in combination. The temperature measured by sensors may comprise electrical signals, which are transmitted to their appropriate destination wireless or through a wired connection.

With continued reference to FIG. 2, sensor may include a plurality of sensing devices, such as, but not limited to, temperature sensors, humidity sensors, accelerometers, electrochemical sensors, gyroscopes, magnetometers, inertial measurement unit (IMU), pressure sensor, proximity sensor, displacement sensor, force sensor, vibration sensor, air detectors, hydrogen gas detectors, and the like. Sensor may be configured to detect a plurality of data, as discussed further below in this disclosure. A plurality of data may be detected from sensor.

With continued reference to FIG. 2, sensor may include a sensor suite which may include a plurality of sensors that may detect similar or unique phenomena. For example, in a non-limiting embodiment, a sensor suite may include a plurality of voltmeters or a mixture of voltmeters and thermocouples. System 200 may include a plurality of sensors in the form of individual sensors or a sensor suite working in tandem or individually. A sensor suite may include a plurality of independent sensors, as described in this disclosure, where any number of the described sensors may be used to detect any number of physical or electrical quantities associated with a charging connection. Independent sensors may include separate sensors measuring physical or thermal quantities that may be powered by and/or in communication with circuits independently, where each may signal sensor output to a control circuit. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained.

With continued reference to FIG. 2, sensor is configured to transmit a sensor output signal representative of sensed information. As used in this disclosure, a “sensor signal” is a representation of a sensed information that sensor may generate. A sensor signal may include any signal form described in this disclosure, for example digital, analog, optical, electrical, fluidic, and the like. In some cases, a sensor, a circuit, and/or a controller may perform one or more signal processing steps on a signal. For instance, sensor, circuit, and/or controller may analyze, modify, and/or synthesize a signal in order to improve the signal, for instance by improving transmission, storage efficiency, or signal to noise ratio.

With continued reference to FIG. 2, exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which vary continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued, and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

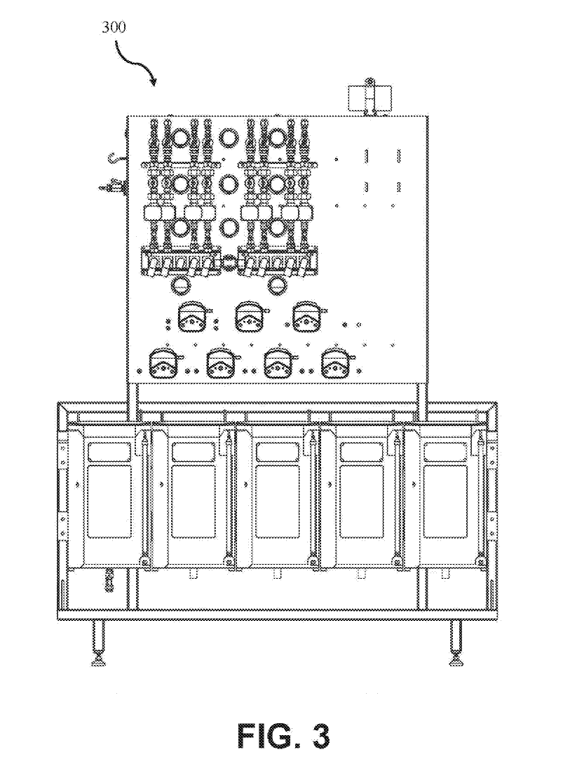

Referring now to FIG. 3, an exemplary embodiment of dispensing system 300 is described. In one or more embodiments, dispensing system 300 may lack an airbox in instances in which the injection of air may not be required and/or needed within mixture.

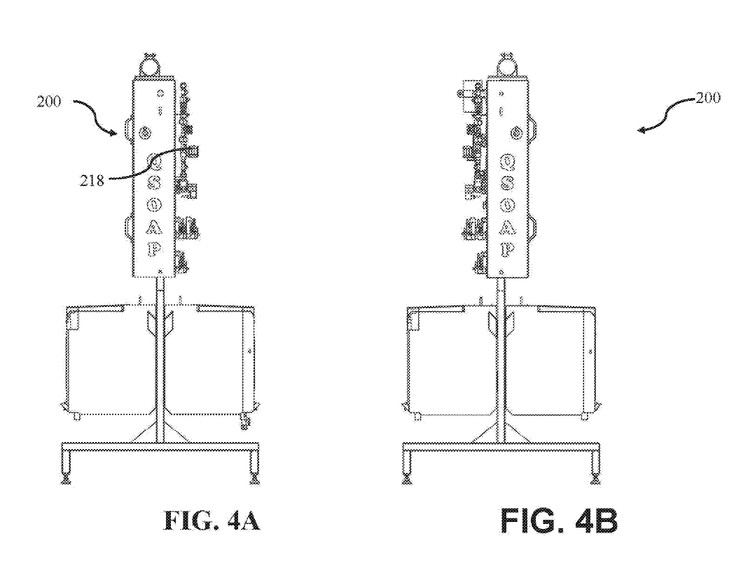

Referring now to FIGS. 4A-4B, an exemplary side view of dispensing system 200 is described. In one or more embodiments, dispensing system 200 may include a panel 218 wherein components of dispensing system 200 may be housed within panel 218. In one or more embodiments, components of dispensing system 200 may include hosing, piping, wiring and/or any other components that provide a fluidic and/or electrical connection between two portions of dispensing system 200. In one or more embodiments, elements of dispensing system may be housed in one or more skids based on installation requirements.

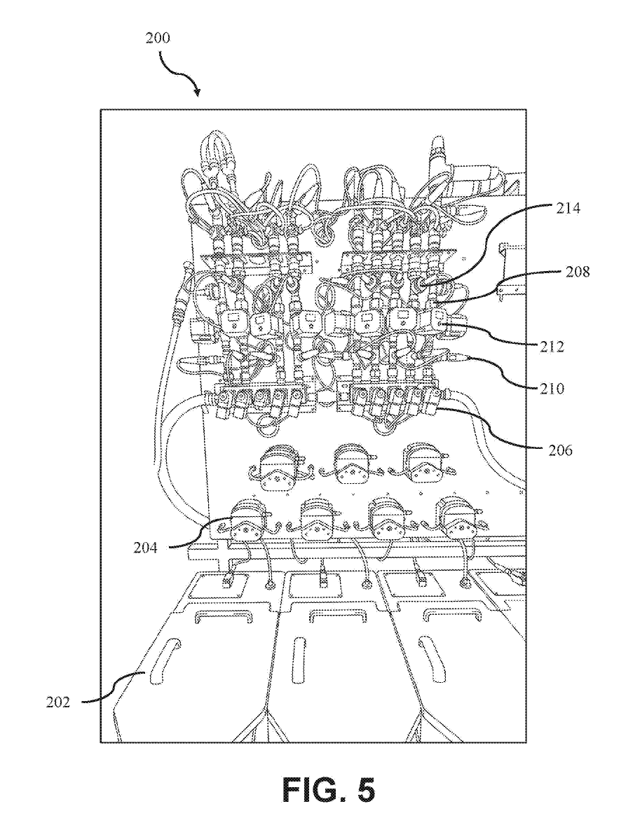

Referring now to FIG. 5, yet another exemplary embodiment of dispensing system 200 is described. In one or more embodiments, dispensing system 200 includes one or more storage tanks 202. In one or more embodiments, storage tanks 202 may be used to store active agents such as soap, soap mixture and/or the like. In one or more embodiments, pumps such as peristaltic pumps 204 may be fluidly connected to storage tanks, wherein active agents within storage tanks may be extracted using peristaltic pumps 204. In one or more embodiments, dispensing system 200 may further include one or more water solenoids 206 configured to provide a fluid, such as water to dispensing system 200. In one or more embodiments, dispensing system 200 may further include a pressure sensor 210 configured to identify a pressure of a fluid exiting water solenoid. In one or more embodiments, water solenoid may supply fluid to designated channel wherein pressure sensor 210 may identify a pressure of fluid prior to navigation through valve 212. In one or more embodiments, valve may be configured to control a flow rate of fluid through designated channel 208. In one or more embodiments, dispensing system 200 may contain valve 212 configured to control a fluid navigating from water solenoid 206. In one or more embodiments, dispensing system 200 may further include a flow meter 214 configured to monitor a flow of fluid through valve. In one or more embodiments, flow meter may identify a flow fluid through a venturi valve as described in further detail below. In one or more embodiments, a controller as described in this disclosure may monitor a flow of fluid through flow meter 214, wherein controller may be configured to control a flow using automated valve 212.

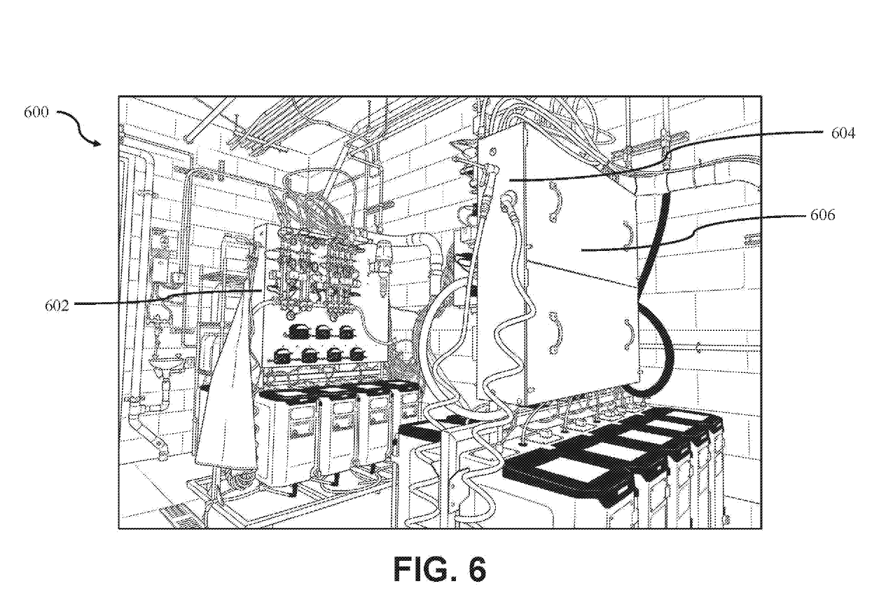

Referring now to FIG. 6, an exemplary embodiment of a dispensing station 600 is described. In one or more embodiments, dispensing station 600 may include more than one dispensing systems situated proximally to and/or parallel to one another. In one or more embodiments, dispensing station 600 may include multiple dispensing systems. In one or more embodiments, the use of multiple dispensing systems may allow for redundancy. In one or more embodiments, each dispensing system may be referred to as a ‘Skid,’ wherein a first dispensing station may be referred to as Skid 1 or a first skid 602 and a second dispensing station may be referred to as Skid 2 or a second skid 604. In one or more embodiments, dispensing station may include soap storage to hold additional soaps and/or active agents.

With continued reference to FIG. 6, in one or more embodiments, dispensing station 600 may be bifurcated into a first skid 602 (e.g., a left-hand skid) and a second skid 604 (e.g., a right-hand skid), wherein the functionality and dispensing channels are distributed between the two skids to facilitate modular installation and transport. The first and second skids may be configured as self-contained, mobile units having a footprint compatible with standard pallet jacks and forklifts. In one or more embodiments, each skid may be designed to require only a limited set of external utility connections to become operational, such as an Ethernet connection, a power connection (e.g., 277V), a water supply inlet, and a compressed air inlet. In one or more embodiments, the first skid and second skid may share a common hardware architecture while executing distinct functional roles based on their position within a wash sequence. For example, the first skid may house components related to initial wash phases (e.g., pre-soaks, wheel cleaners), while the second skid may house components related to finishing phases (e.g., waxes, drying agents, tire shine). Despite these functional differences, the first and second skids may utilize identical controller boards. In one or more embodiments, the controller board may be configured to automatically determine its identity as either a first-skid controller or a second-skid controller upon boot-up. This identification may be achieved through a hardware “strapping” mechanism, such as a specific pin in the wiring harness that is pulled to a ground state on one skid but left floating or pulled high on the other, allowing the firmware to load the appropriate configuration settings automatically.

With continued reference to FIG. 6, in one or more embodiments, each skid may include a frame and an enclosure 606 designed for rapid maintenance access. The enclosure 606 (also referred to as a rear manifold herein) may feature a flip-up rear access door supported by one or more gas struts, allowing an operator to access internal plumbing, pumps, and manifold blocks without removing the entire housing. In one or more embodiments, the frame of each skid may include an integrated horizontal support bar positioned above the pump assemblies. This support bar may include one or more pre-drilled apertures configured to receive an eye-bolt or similar lifting hardware, enabling the use of a hoist to lift and service heavy components, such as a water pump or motor, directly within the skid footprint. In one or more embodiments, the dual-skid architecture provides localized resource management. For example, a central air manifold may be localized to the first skid to distribute compressed air to both units, while a specialized high-viscosity circuit, such as a tire shine dispensing system, may be localized to the second skid. In one or more embodiments, the skids communicate over a local network (e.g., via the Ethernet connection) to synchronize dispensing timing and sensor data, ensuring that the bifurcated system operates as a single, cohesive dispensing station 600. This modularity allows for the independent replacement or upgrading of one skid without requiring the decommissioning of the entire dispensing station 600.

With continued reference to FIG. 6, in one or more embodiments, dispensing station 600 may include an enclosure 606 specifically configured to facilitate on-site maintenance and component replacement without requiring complete disassembly of the skid frame. The enclosure 606 may include a rear access panel moveably coupled to the frame. In a preferred embodiment, the rear access panel may be configured as a flip-up door supported by one or more gas struts (e.g., pneumatic springs). The gas struts may be configured to provide a controlled opening force and to maintain the rear access panel in an open, elevated position, thereby providing unobstructed, hands-free access to the internal components of the skid, including the manifold blocks, peristaltic pumps, and fluid routing.

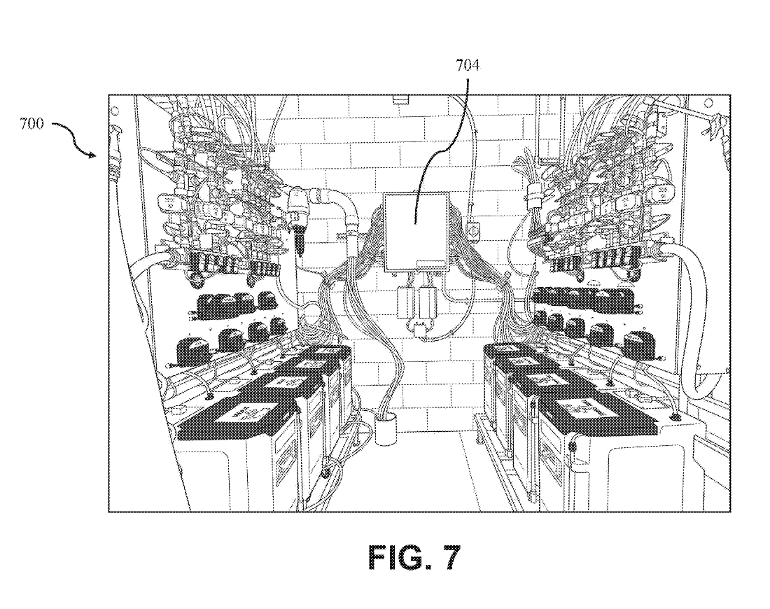

Now referring to FIG. 7, yet another exemplary embodiment of a dispensing station 700 is described. In one or more embodiments, dispensing station 700 may include a controller 704 communicatively connected to dispensing system 200. In one or more embodiments, controller 704 may include any controller as described in this disclosure. A “controller” for the purposes of this disclosure is a computing device configured to receive data and generate commands for dispensing system 200. For example, and without limitation, controller 704 may receive data from a sensor such as pressure sensor and/or flow meter and output a command for valve 212. In one or more embodiments, controller 704 includes a computing device. In one or more embodiments, controller 704 includes a processor. Processor may include, without limitation, any processor described in this disclosure. Processor may be included in a and/or consistent with computing device. In one or more embodiments, processor may include a multi-core processor. In one or more embodiments, multi-core processor may include multiple processor cores and/or individual processing units. “Processing unit” for the purposes of this disclosure is a device that is capable of executing instructions and performing calculations for a computing device. In one or more embodiments, processing units may retrieve instructions from a memory, decode the data, secure functions, and transmit the functions back to the memory. In one or more embodiments, processing units may include an arithmetic logic unit (ALU) wherein the ALU is responsible for carrying out arithmetic and logical operations. This may include, addition, subtraction, multiplication, comparing two data, contrasting two data and the like. In one or more embodiments, processing unit may include a control unit wherein the control unit manages execution of instructions such that they are performed in the correct order. In none or more embodiments, processing unit may include registers wherein the registers may be used for temporary storage of data such as inputs fed into the processor and/or outputs executed by the processor. In one or more embodiments, processing unit may include cache memory wherein memory may be retrieved from cache memory for retrieval of data. In one or more embodiments, processing unit may include a clock register wherein the clock register may be configured to synchronize the processor with other computing components. In one or more embodiments, processor may include more than one processing unit having at least one or more arithmetic and logic units (ALUs) with hardware components that may perform arithmetic and logic operations. Processing units may further include registers to hold operands and results, as well as potentially "reservation station" queues of registers, registers to store interim results in multi-cycle operations, and an instruction unit/control circuit (including e.g. a finite state machine and/or multiplexor) that reads op codes from program instruction register banks and/or receives those op codes and enables registers/arithmetic and logic operators to read/output values. In one or more embodiments, processing unit may include a floating-point unit (FPU) wherein the FPU may be configured to handle arithmetic operations with floating point numbers. In one or more embodiments, processor may include a plurality of processing units wherein each processing unit may be configured for a particular task and/or function. In one or more embodiments, each core within multi-core processor may function independently. In one or more embodiments, each core within multi-core processor may perform functions in parallel with other cores. In one or more embodiments, multi-core processor may allow for a dedicated core for each program and/or software running on a computing system. In one or more embodiments, multiple cores may be used for a singular function and/or multiple functions. In one or more embodiments, multi-core processor may allow for a computing system to perform differing functions in parallel. In one or more embodiments, processor may include a plurality of multi-core processors. Computing device may include any computing device as described in this disclosure, including without limitation a microcontroller, microprocessor, digital signal processor (DSP), and/or system on a chip (SoC) as described in this disclosure. Computing device may include, be included in, and/or communicate with a mobile device such as a mobile telephone or smartphone. Computing device may include a single computing device operating independently or may include two or more computing devices operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but are not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

With continued reference to FIG. 7, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 7, computing device may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” (described further below in this disclosure) to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 7, system 200 and/or controller 704 may include a memory communicatively connected to processor, wherein the memory contains instructions configuring processor to perform any processing steps as described herein. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device. Communicative connecting may also include indirect connections via, for example without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 7, memory may include a primary memory and a secondary memory. “Primary memory” also known as “random access memory” (RAM) for the purposes of this disclosure is a short-term storage device in which information is processed. In one or more embodiments, during use of computing device, instructions and/or information may be transmitted to primary memory wherein information may be processed. In one or more embodiments, information may only be populated within primary memory while a particular software is running. In one or more embodiments, information within primary memory is wiped and/or removed after computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor may access the information from primary memory.

With continued reference to FIG. 7, system 200 and/or controller 704 may include and/or be communicatively connected to a server, such as but not limited to, a remote server, a cloud server, a network server, and the like. In one or more embodiments. In one or more embodiments, computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by system computing device. In one or more embodiments, computing device may transmit processes to server wherein computing device may conserve power or energy.

With continued reference to FIG. 7, one or more processes as described in this disclosure may be performed by server. In one or more embodiments, processor may communicate with server to receive information needed for one or more instructions tasked by processor. In one or more embodiments, server may include one or more systems and/or software configured to provide information and/or data to processor. A “server” for the purposes of this disclosure is a system that provides resources, data, or services to other computing systems over a network. For example, without limitation, server may include a web server, a file server, a database server, and/or the like.

With continued reference to FIG. 7, one or more processes as described in this disclosure may be performed by server. In one or more embodiments, processor may communicate with server to receive information needed for one or more instructions tasked by processor. In one or more embodiments, server may include one or more systems and/or software configured to provide information and/or data to processor. A “server” for the purposes of this disclosure is a system that provides resources, data, or services to other computing systems over a network. For example, without limitation, server may include a web server, a file server, a database server, and/or the like.

With continued reference to FIG. 7, controller 704 may be configured to receive a datum from pressure sensor, flow meter, and/or any other device capable of sensing a phenomenon. In one or more embodiments, controller 704 may be configured to transmit commands to dispensing system 200 such as to valve 212 to control fluid rate. In one or more embodiments, dispensing system 200 may include a shut off switch. In one or more embodiments, shut off switch may allow for the immediate ceasing of electrical power to dispensing system 200.

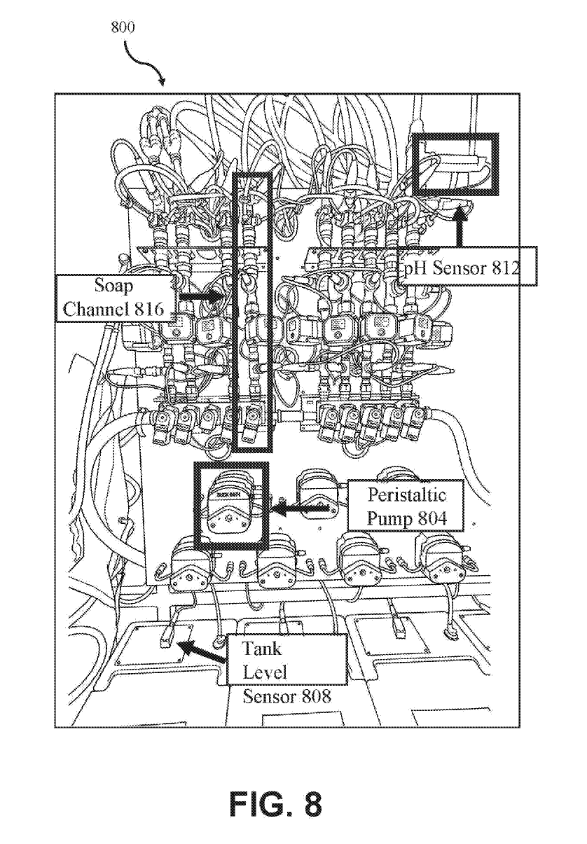

Referring now to FIG. 8, yet another exemplary embodiment of dispensing system 200 is described. n one or more embodiments, dispensing system 800 may include peristaltic pumps 804 configured to extract active agent from storage tanks. In one or more embodiments, dispensing system 800 may include a PH sensor 812 configured to monitor fluid entering through water solenoid. In one or more embodiments, water entering through water solenoid may contain an unexpected and/or undesired PH, wherein PH sensor 812 may be configured to identify a PH of fluid entering through water solenoid. In one or more embodiments, dispensing system 800 may include a soap channel 816. In one or more embodiments, soap channel 816 may be consistent with designated channel. In one or more embodiments, soap channel 816 may include a portion of dispensing system in which fluid and active agent are combined to create mixture. In one or more embodiments, the PH sensor 812 may be located on the water main and designed to monitor TDS and PH of incoming city water. PH sensor 812 may be positioned on the outlet of a soap channel 816 that is easily accessible as the soap channel 816 applies water to rinse the bottom of the car without soap. In one or more embodiments, soap channel 816 may include pressure sensors, valves, flow meters, venturi valves, and/or the like. In one or more embodiments, soap channel 816 may include one or more pressure sensors, flow meters and/or valves as described in this disclosure to monitor back pressure and any potential issues. In an embodiment, sensors may be used to monitor backflow of active agent and/or fluid within soap channel 816. In one or more embodiments, a system, such as a system as described in reference to at least FIG. 19, may be configured to monitor sensors, collect a datum, and adjust flow valves, flow rates and, peristaltic pumps and/or the like accordingly. In one or more embodiments, dispensing system may include a tank level sensor 808. Tank level sensor 808 may include a sensor configured to measure an amount of active agent within each storage tank. In one or more embodiments, tank level sensor 808 may include any sensor as described in this disclosure and configured to identify an amount of active agent within storage tank.

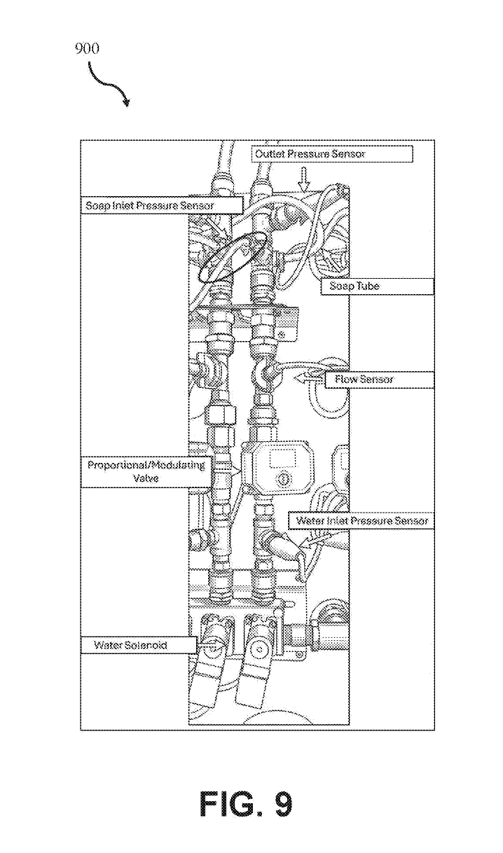

Referring now to FIG. 9, an exemplary embodiment of a soap channel 900 is described. In one or more embodiments, soap channel may be consistent with designated channel as described above. In one or more embodiments, soap channel may include a pipe and/or a tubular structure configured to route fluid and mix active agent with fluid to provide mixture. In one or more embodiments, soap channel may include water solenoid configured to supply fluid to soap channel. In one or more embodiments, soap channel 900 may include a pressure sensor configured to identify a pressure of fluid from water solenoid. In one or more embodiments, soap channel may include a proportional/modulating valve configured to modulate and control a flow of fluid and/or water from water solenoid and through soap channel. In one or more embodiments, soap channel 900 may include a flow sensor configured to identify a flow of fluid out of valve. In one or more embodiments, soap channel 900 may include a soap tube. In one or more embodiments, peristaltic pump may navigate active agent through soap tube and into soap channel. In one or more embodiments, soap channel may be fluidly connected to soap tube wherein soap tube may supply active agent to soap channel. In one or more embodiments, soap tube may include a soap inlet pressure sensor and configured to identify a pressure of soap tube. In one or more embodiments, soap inlet pressure sensor may be configured to identify pressure buildup within soap tube. In one or more embodiments, soap and/or active agent within soap tube may combine with fluid within soap channel to create mixture. In one or more embodiments, mixture may contain active agent and fluid. In one or more embodiments, an outlet of soap channel may include mixture. In one or more embodiments, soap channel 900 may include an outlet pressure sensor. In one or more embodiments, outlet pressure sensor may be configured to identify a pressure of mixture at an outlet of soap channel.

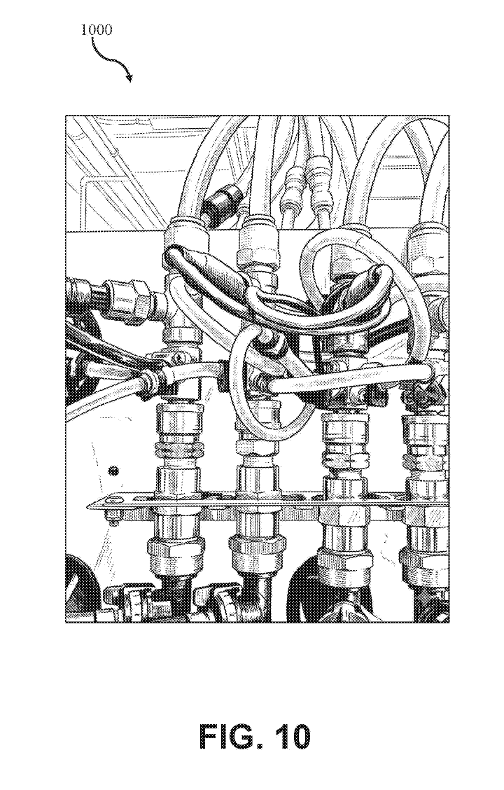

Referring now to FIG. 10, an exemplary embodiment of an injector system 1000 is described. In one or more embodiments, injector system 1000 includes a component configured to inject active agent into fluid within soap channel. In one or more embodiments, injector system 1000 may include a venturi-based injector that uses the flow of water to draw and mix a concentrated chemical into a water stream at a specific dilution ratio. In one or more embodiments, injector system 1000 is installed in a water line. As water flows through the injector, a venturi effect creates suction that pulls active agent and/or soap from a storge tank and/or from peristaltic pump. The active agent is mixed with the water (e.g. fluid) and dispensed through a hose, sprayer, or other application tool. In one or more embodiments, injector system 1000 may include a DEMA injector. In one or more embodiments, injector system 1000 may be integrated within and/or a component of soap channel. In an injector system 1000 such as a DEMA injector, the Venturi effect is created using a specifically shaped internal passage within the injector system 1000. This passage includes a constricted throat section between two wider areas. As water enters the injector and passes through this narrowing, its velocity increases while the pressure drops significantly at the throat. This low-pressure zone is located adjacent to a soap inlet such as soap tube. Because the pressure at this port is lower than the pressure within the connected soap tube or reservoir, the pressure differential causes the active agent to be drawn into the water stream without the need for a mechanical pump. The injector’s internal check valve ensures that fluid only flows in the intended direction, preventing backflow. After the active agent is pulled in, the water and active agent mix in the widening section beyond the throat, where velocity decreases and pressure begins to recover. This process enables continuous mixing of soap tube with water during flow. In one or more embodiments, injector system 1000 may further ease pressure of peristaltic pump by extracting active agent that is present within soap tube. This reduces the stress on peristaltic pump to navigate active agent through soap tube, while the peristaltic pump (being a positive displacement pump) meters the flow rate of the active agent.

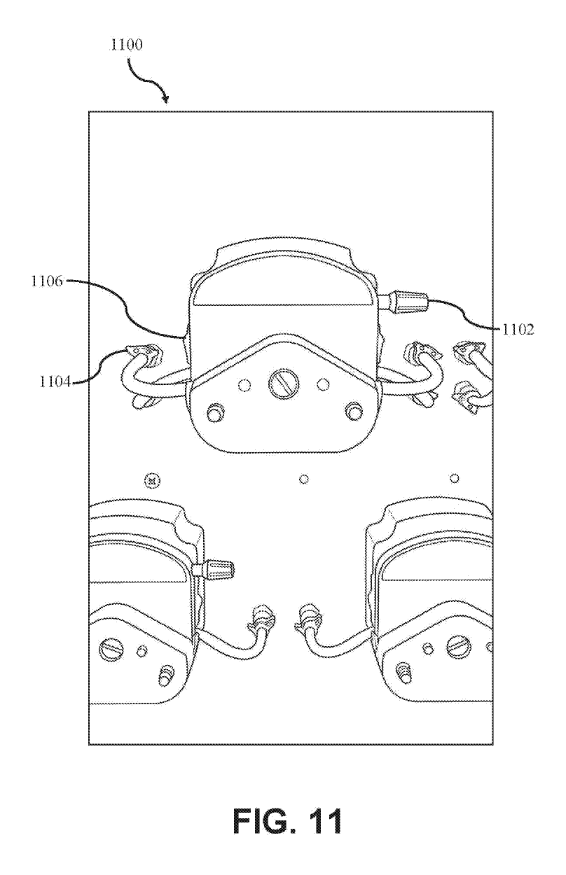

Referring now to FIG. 11, an exemplary embodiment of a peristaltic pump 1100 is described. In one or more embodiments, peristaltic pump may be configured to navigate active agent from storage tanks and through soap tube. In one or more embodiments, peristaltic pump may operate by compressing and releasing a flexible tube to move fluid (e.g., active agent) through it in a controlled manner. In one or more embodiments, peristaltic pump may include a pump head. The pump head may include the central housing where the tubing is placed and where the rollers or shoes compress the tubing to push fluid forward. In one or more embodiments, peristaltic pump may include a pump tube, such as soap tube. The pump tube may include an elastomeric tube that carries the active agent. The flexibility of pump tube allows it to be repeatedly compressed and released. In one or more embodiments, peristaltic pump may include a ribbed connector, typically made of plastic or metal, which secures the ends of the tubing to external supply or discharge lines. The ribs provide grip and prevent slippage when the tube is clamped. In one or more embodiments, peristaltic pump may include tube clamps 1104. The tube clamps 1104 may include a device that holds the tube securely onto the hose barbs or within the pump housing to prevent leaks and disconnections under pressure. In one or more embodiments, peristaltic pump may include a pump lever 1102. The pump lever 1102 may include a mechanical arm or handle used to open or close the pump head, often used to ease access when inserting or removing tubing. In one or more embodiments, peristaltic pump may include a tube retainer 1106. The tube retainer 1106 may include small brackets or clips inside the pump head that keep the tube properly aligned and held in place during operation, preventing the tube from shifting or kinking.

With continued reference to FIG. 11, in one or more embodiments, a controller, as described in this disclosure, may be configured to execute an adaptive calibration routine to maintain the high-precision delivery of the peristaltic pump. This routine may calculate a “pump trim” value by correlating the commanded rotations of the pump motor with the actual volumetric displacement of the active agent as measured by the tank level sensors (e.g., via the waveguide tube). By comparing the predicted flow rate against the verified liquid depletion in the storage tank, the controller automatically adjusts the motor speed or duration to account for changes in chemical viscosity or atmospheric conditions, ensuring precise chemical ratios are maintained during the dispensing process. In one or more embodiments, the peristaltic pump may be configured in dual-motor or dual-head architecture to support high-volume applications or to provide system redundancy. In this configuration, two motors may be wired in parallel to operate as a single logical unit, or a single motor may drive multiple pump heads. This parallel arrangement allows for dispensing system to meet the increased volumetric demands of specific wash cycles by delivering active agent through multiple parallel circuits simultaneously. In one or more embodiments, these dual circuits may be synchronized through a single air channel to ensure uniform delivery and foam generation across multiple applicators.

With continued reference to FIG. 11, in one or more embodiments, peristaltic pump may be fluidly connected to a downstream Venturi-based dilution block. The pump may be configured to meter the concentrated active agent into the suction port of the Venturi, where it is combined with pressurized water (e.g., at approximately 150 PSI) provided by the water solenoid 116. This configuration utilizes the positive displacement characteristics of the peristaltic pump to provide a consistent mass flow of chemical that is independent of the pressure fluctuations within the main water line, while the Venturi provides the high-velocity mixing and vacuum necessary for efficient foam creation. In one or more embodiments, the peristaltic pump is controlled via a digital interface.

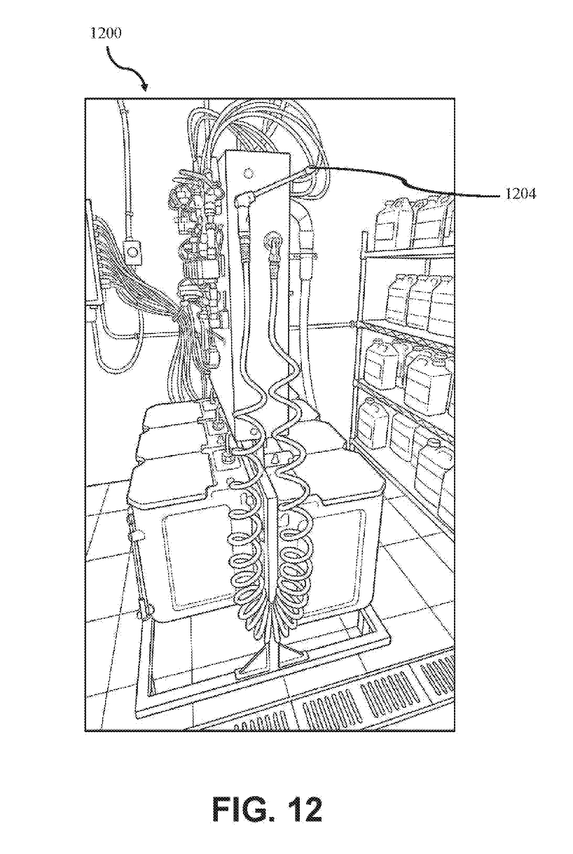

Referring now to FIG. 12, an exemplary embodiment of a water-only dispensing system 200 is described. In one or more embodiments, a water-only dispensing system may include a water blaster 1204. In one or more embodiments, water blaster 1204 may include a pressurized hose configured to provide water at high pressure. In one or more embodiments, water blaster 1204 may be fluidly connected to dispensing system. In one or more embodiments, water blaster 1204 may provide water at high pressure to clean dispensing system 1200. In one or more embodiments, dispensing system 1200 may include a tank training tube as well.

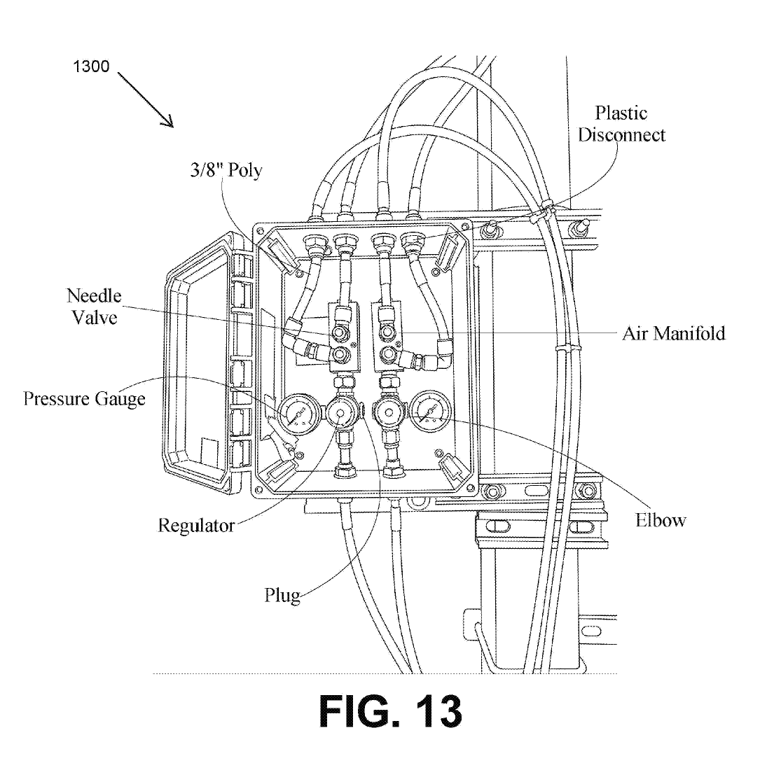

Referring now to FIG. 13, an exemplary embodiment of an airbox 1300 is described. In one or more embodiments, airbox 1300 may include a system configured to provide air to mixture within dispensing system. In one or more embodiments, airbox 1300 may be integrated and/or connected to dispensing system and configured to supply air to mixture. In one or more embodiments, airbox 1300 may be used in foaming systems. In one or more embodiments, airbox 1300 may include a compact, enclosed unit designed to regulate and distribute air into a soap and water mixture, enabling the creation of thick, clinging foam. In one or more embodiments, airbox 1300 may provide air to soap channel in order to distribute air into mixture. Proper air pressure regulation, along with correct needle valve settings, is essential for creating a consistent and effective soap and water foam mixture. The airbox 1300 may play a critical role in the regulation and distribution of compressed air to multiple foam applicators. Within the airbox 1300 enclosure, a secondary pressure regulator may be responsible for setting the final delivery pressure of the air that is sent to a foam system. The pressure gauge located in the airbox 1300 provides a direct indication of the output pressure from the secondary regulator, offering a clear view of the pressure level being fed to the downstream components, specifically, the needle valves. The output from the secondary regulator is routed to a series of needle valves, which serve as variable flow restrictors. These valves may not be intended to control pressure directly, but rather to fine-tune the airflow to each individual foam applicator. Since the foam applicators are plumbed in parallel, airflow balancing may ensure consistent chemical output across all applicators. The needle valves allow for this relative flow balancing, compensating for differences in line length, elevation, or minor variations in the applicators themselves. In one or more embodiments, a secondary pressure regulator is the primary and final means of controlling the system’s air pressure. The second pressure regulator may be the regulator that determines the maximum air pressure presented to the needle valves. The needle valves, in contrast, may not regulate pressure, but adjust flow within the pressure range established by the secondary regulator. In one or more embodiments, the gauges within airbox 1300 and the gauges within dispensing system may serve different parts of the system. The gauge on the dispensing system reflects conditions upstream (typically at or near the supply regulator), while the airbox gauge reflects the controlled, reduced pressure used specifically for foam application balancing. Air pressure is the driving force that introduces air into mixture, and if it is too low or too high, the foam texture can be compromised, resulting in either watery solution or overly dry, unstable foam. These individual needle valves allow for fine-tuning the foam output at each point of use, accounting for differences in line length or nozzle type. In one or more embodiments, airbox may include plugs. In one or more embodiments, plugs may include threaded inserts or caps used to seal unused ports or openings in the airbox manifold or housing. Plugs may ensure no air escapes from areas where connections aren’t required, maintaining pressure and integrity in the system. In one or more embodiments, airbox 1300 may include air manifolds. Air manifolds may distribute compressed air from a single source to multiple outlets. In one or more embodiments, a needly valve distribution manifold may distribute air to multiple applicators on a single arch. In one or more embodiments, airbox 1300 may be configured to provide air to multiple systems as described in this disclosure, such as for example, multiple dispensing systems, multiple soap channels and/or the like. In one or more embodiments, airbox 1300 may be configured to provide air to a single system and/or device containing multiple air outlets. In one or more embodiments, airbox 1300 may be used to supply air to dry a vehicle, supply air to create foam within a mixture and/or the like. In the airbox 1300, the manifold channels air to various points in the system, such as foam injectors or active agent mixing stations, allowing for even distribution and centralized control. In one or more embodiments, airbox 1300 may include plastic disconnects. Plastic disconnects, also known as quick-disconnect fittings or push-to-connect fittings, allow for fast and tool-free connection or disconnection of air lines. They may be made of durable plastic and can be used to simplify maintenance or changeouts in the air delivery system. In one or more embodiments, airbox 1300 may include pressure regulators. Pressure regulators may be installed to control the air pressure entering the system. Pressure regulators may allow for fine-tuning the air input, ensuring the correct pressure is applied to mix with the soap and water without over-pressurizing or under-delivering air to the foam generator. In one or more embodiments, airbox 1300 may include pressure gauges. Pressure gauges may provide a visual indication of the air pressure within the airbox or output lines. Gauges may help with troubleshooting, adjustment, and ensuring the system operates within optimal pressure ranges for foaming. In one or more embodiments, airbox 1300 may include needle valves. Needle valves may include precision valves used to finely adjust the flow rate of air entering the foam generation section. By turning the needle valve, operators can control how much air is introduced into the mixture, which directly influences foam texture and volume. In one or more embodiments, airbox 1300 may include plastic or poly tubing. Polyethylene or polyurethane tubing may bused to carry air from the airbox to various parts of the foaming system. It is lightweight, flexible, and chemically resistant, making it suitable for use in environments where chemical exposure and repeated flexing are common.

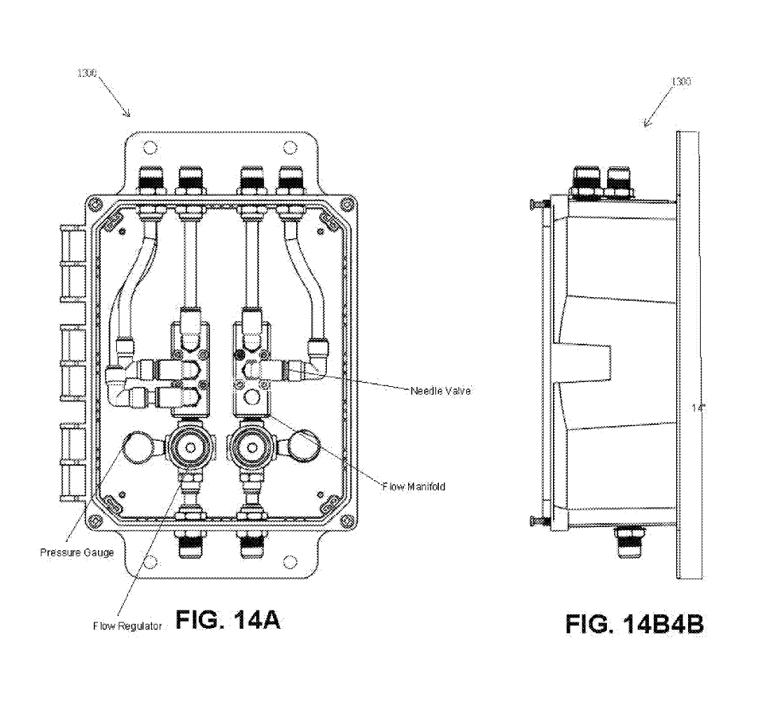

FIGS. 14A-14B are exemplary embodiments of the airbox 1300. In one or more embodiments, airbox 1300 may include needle valves, a flow manifold, a pressure gauge to identify pressure, a flow regulator to regulator flow of air and/or the like. In one or more embodiments, airbox may include a housing within components of airbox may be stored in housing. In one or more embodiments, housing may include a door and/or an opening allowing an individual to access components of airbox 1300.

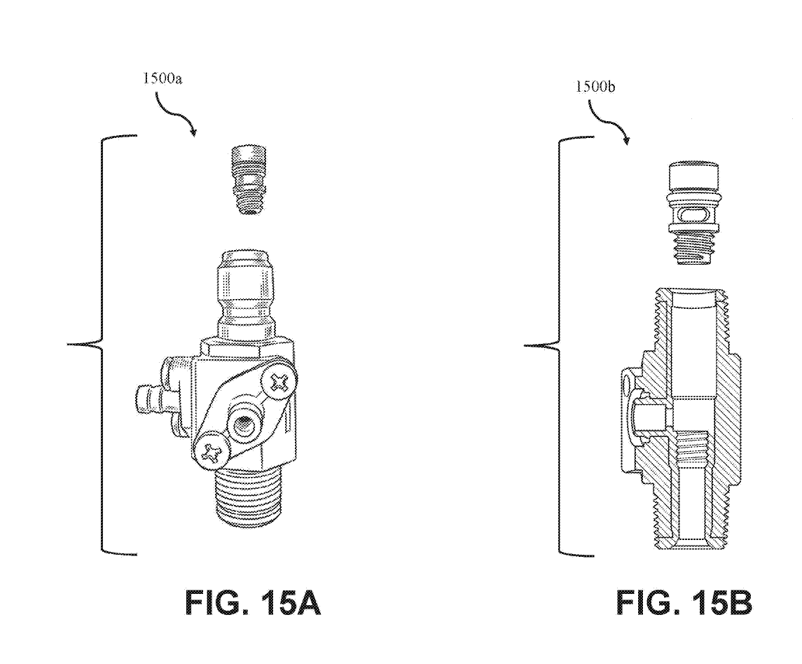

Referring now to FIG. 15A, an exemplary embodiment of an injector system 1500a is described. In one or more embodiments, injector system 1500a may include any injector system as described in this disclosure. In one or more embodiments, injector system 1500a may be used to combine a mixture of fluid and active agent such as soap and water. In one or more embodiments, injector system 1500a may create a negative pressure differential within soap tube, such that active agent within soap tube is pulled into soap channel. In one or more embodiments, injector system 1500a includes a venturi valve. A Venturi valve operates based on the principle of fluid dynamics in which a fluid's velocity increases as it passes through a constricted section of pipe, causing a drop in pressure. The valve contains a tapered internal chamber that begins with a wider inlet, narrows at the center, and then widens again at the outlet. This narrowing is known as the Venturi nozzle, and at its most restricted point lies the Venturi nozzle orifice, which is a precisely sized opening that controls the rate at which pressure drops, and suction occurs. As fluid, typically water, flows through the valve and into the nozzle, its speed increases at the orifice, and static pressure decreases sharply at that point. This low-pressure zone is positioned near a side port or inlet, which allows another fluid, such as active agent to be drawn into the main flow (e.g., soap channel) from the soap tube due to the pressure differential. The active agent enters the stream of fluid through a suction port on soap channel and is mixed with the moving water in the widening section beyond the orifice. The overall structure ensures that once initiated, this process continues as long as flow is maintained, with no moving parts required for the suction and mixing action. In one or more embodiments, use of a venturi nozzle may allow for a system to utilize the energy of flowing water to pump active agent through soap tube. In one or more embodiments, the negative pressure differential within soap tube may ensure that peristaltic pump does not need to increase work to ensure that active agent is pumped through soap tube. In one or more embodiments, injector system 1500a may reduce pressure placed on peristaltic pump and thereby increase a lifespan on peristaltic pump.

Referring now to FIG. 15B, an exemplary embodiment of a cross-sectional view of the injector system 1500b is described. The injector system includes a venturi nozzle orifice and a venturi nozzle.

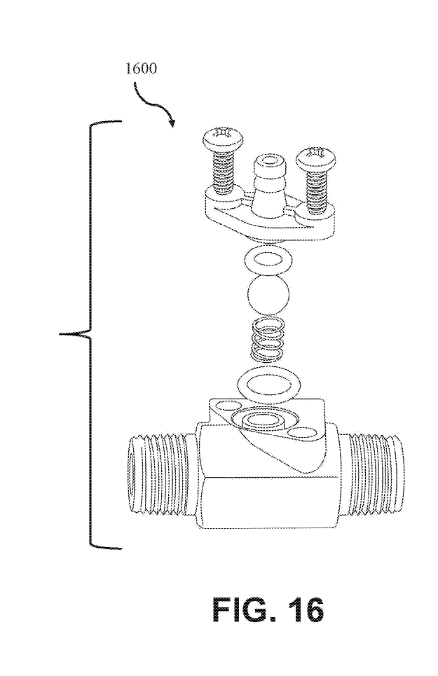

Referring now to FIG. 16, an exploded view of injector system 1600 is described. In one or more embodiments, injector system 1600 includes a barb, O-ring, spring, and ball work. The components of injector system 1600 create an internal check valve and active agent draw system. The barb is a ribbed connector that allows secure attachment of the soap tube. the barb ensures a tight seal and prevents the tubing from slipping off under suction. Just inside the injector body, the O-ring sits around the inlet and provides a watertight seal between the barb fitting and the injector housing, preventing leaks and maintaining proper suction pressure. The spring and ball form a one-way check valve mechanism. The ball rests against a seat inside the injector, held in place by the spring. When the water flow through the injector creates a vacuum at the soap inlet port, the differential pressure lifts the ball off its seat, compressing the spring and allowing chemical to be drawn in through the barb. When the system stops or backpressure is present, the spring pushes the ball back into place, sealing the port and preventing water or active agent from flowing backward into the storage tank.

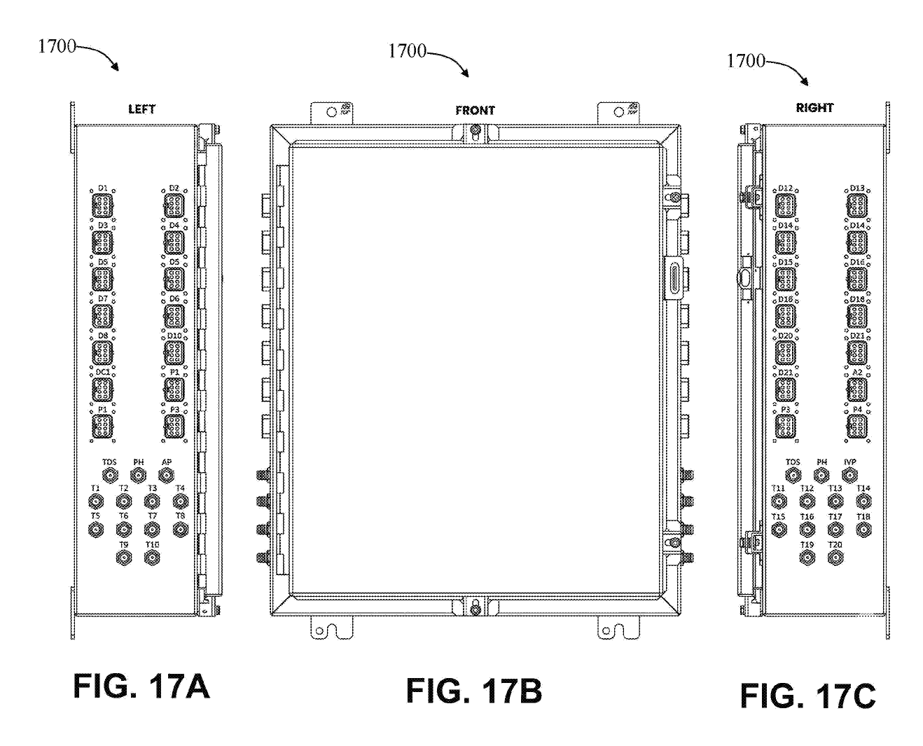

Referring now to FIGS. 17A-17C, an exemplary embodiment of a controller 1700 is described. In one or more embodiments, Controller 1700 might exist as a single controller that operates both skids, or multiple controllers that exist external or internal to each skid, controlling individual skids in concert with each other, with or without orchestration by an attached server. In one or more embodiments, controller 1700 may include any controller as described in this disclosure. In one or more embodiments, controller 1700 may be communicatively connected to dispensing system and configured to receive data from dispensing system. In one or more embodiments, controller 1700 may be configured to receive information from water solenoid, pressure sensor, flow meter, outlet pressure sensor, soap pressure sensor and/or any other sensors and/or electromechanics devices. In one or more embodiments, controller 1700 may be configured to control a flow of active agent and/or fluid by manipulating valves, peristaltic pumps and/or the like. In one or more embodiments, controller 1700 may receive a datum from level sensors, pressure sensors and/or the like and generate commands to various components of dispensing system to increase pressure, increase flow rate and/or the like. In one or more embodiments, controller 1700 may be configured to communicate with a remote device to transmit notifications associated with pressure buildup, changes in flow rate, changes in PH levels and/or the like.

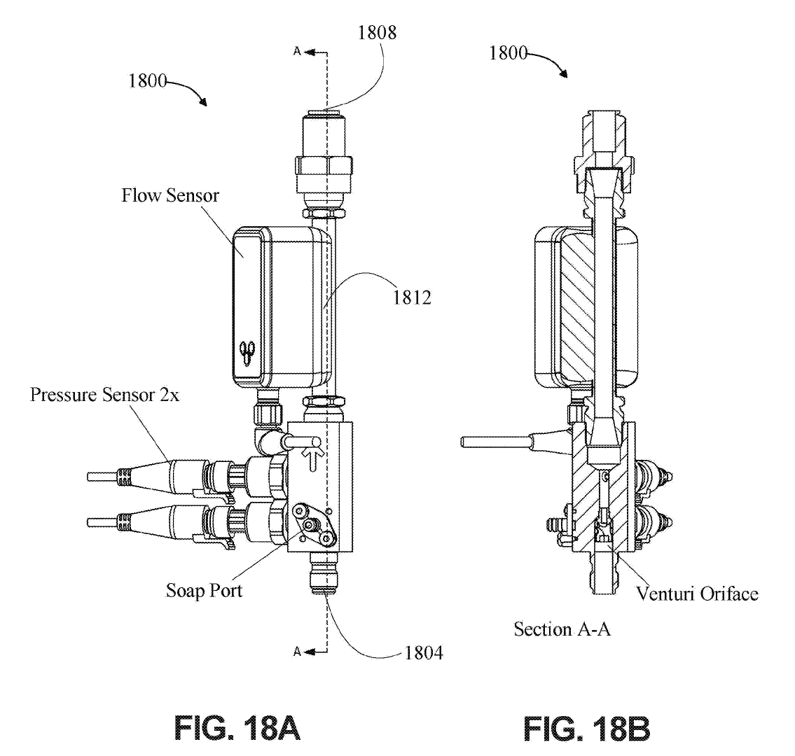

Referring now to FIGS. 18A-18B, exemplary embodiments of a soap channel 1800 are described. FIG. 18A illustrates the soap channel and FIG. 18B illustrates a cross sectional view of the soap channel. In one or more embodiments, soap channel 1800 may include a designated channel 1812 in which water or a fluid enters an inlet 1804 of designated channel 1812 and a mixture of water and active agent exit through an outlet 1808 of designated channel. In one or more embodiments designated channel 1812 may include a portion of an ultrasonic flow sensor. In one or more embodiments, some ultrasonic flow meter design, particularly in-line flow meters, a sensor comes with a built-in pipe section already integrated into the device. As a result, designated channel 1812 may be integrated into the flow meters wherein the built-in pipe may include designated channel 1812 and/or a portion thereof. This means the flow meter is not just attached to designated channel 1812, but it is part and/or a portion of the designated channel 1812. Fluid flows through the internal passage of the designated channel, wherein designated channel may be connected as a medium through which fluid flows through dispensing system. Inside an integrated section, ultrasonic transducers are positioned to send and receive sound waves across the flow of fluid with designated channel 1812. These waves travel diagonally or directly through the liquid inside the built-in pipe. By measuring how long it takes for the ultrasonic signals to move from one side to the other, the flow meter determines the speed of the fluid, and from that, it calculates the flow rate. In one or more embodiments, soap channel 1800 may include a soap port. In one or more embodiments, soap port may allow for the introduction of soap and/or active agent within soap channel 1800. In one or more embodiments, soap port may be fluidly connected to soap tube, wherein active agent may be pumped through peristaltic pump, through soap tube and into soap port. In one or mor embodiments, soap channel 1800 may include pressure sensors configured to monitor a pressure at soap port. In one or more embodiments, pressure sensors may indicate to controller if pressure buildup is occurring within soap part and/or within soap tube connected to soap port. In one or more embodiments, soap channel may include an injector system integrated into a soap channel. In one or more embodiments, a venturi orifice may be situated within a designated channel and/or piping of soap channel and configured to pull active agent through soap port. In one or more embodiments, flow sensor may measure the flow of fluid and/or active agent in order to identify how much fluid is being utilized. In one or more embodiments, flow meter may indicate a concentration of active agent within fluid by identifying an amount of water entering inlet 1804 and an amount of mixture exiting outlet 1808. In one or more embodiments, flow rates of active agent may be monitored and/or recorded using peristaltic pump, while flow rates of fluid may be monitored using flow meter. In one or more embodiments, a flow rate from peristaltic pump and a flow rate from flow meter may be used to identify a dilution ratio. In one or more embodiments, flow meter may include a non-intrusive or clamp-on flow sensor. These sensors typically use ultrasonic or electromagnetic technology to measure flow rates without physically touching the fluid inside. In one or more embodiments, the ultrasonic flow meter may be positioned downstream of the soap mixture, active agent and/or mixture in order to avoid potential damage to the sensor due to high PH and chemicals within active agent. In one or more embodiments, ultrasonic flow sensor and/or flow meter may not contact fluid and/or fluid mixture but rather identify fluid and/or mixture through a separation, such as a wall. These sensors may include two transducers that are clamped to the outside surface of the pipe. They work by sending and receiving ultrasonic sound waves through the pipe wall and the flowing fluid inside. The time it takes for the sound waves to travel with and against the flow is measured, and the difference in transit times is used to calculate the velocity of the fluid. From there, flow rate is derived based on the pipe’s internal diameter. In one or more embodiments, flow meter may be situated external to fluid and/or mixture and identify a flow of fluid or mixture within a piping. In one or more embodiments, water flow metering on soap channel 1800 is achieved exclusively through the venturi nozzle’s flow orifice, eliminating the need for a separate flow control valve. The orifice is precisely sized to deliver a fixed flow rate, simplifying system architecture and reducing component count. A soap port sensor may be incorporated to monitor conditions that could compromise proper venturi operation. One potential issue is that if inlet water pressure drops below a critical threshold, the venturi may lose suction, resulting in a reversal to positive pressure at the chemical inlet. This condition can disrupt the intended draw of chemical concentrate and potentially force water into the chemical reservoir. Additionally, the system may encounter excessive backpressure at the outlet due to downstream restrictions such as kinked lines or clogged applicators. Under such conditions, the venturi’s suction capability can also be impaired. The soap port sensor enables detection of these abnormal pressure states, ensuring operational reliability and proper dilution performance. In one or more embodiments, other embodiments as described in this disclosure may incorporate alternative flow control mechanisms or sensing strategies, depending on application requirements or system complexity.

Referring now to FIG. 19, an exemplary system 1900 for creating mixtures is described. In one or more embodiments, mixtures 1964 may include a combination of an active agent 1912 and a fluid 1904 such as water 1908. In one or more embodiments, active agent 1912 may include a cleaning product, such as soap, a mixture of chemicals used for cleaning vehicles and/or the like. In one or more embodiments, active agent 1912 may serve as the primary agent that is needed to clean a vehicle or another component. In one or more embodiments, mixtures 1964 may include a combination of fluid and active agent 1912 with precise amounts, such as for example, an 5% concentration of active agent 1912 within fluid and/or the like.

With continued reference to FIG. 19, system 1900 includes a dispensing system 1916. In one or more embodiments, dispensing system 1916 may include any dispensing system 1916 as described in this disclosure. In one or more embodiments, dispensing system 1916 includes a soap system 1920. A “soap system” as described in this disclosure refers to one or more components associated with the storage and movement of active agent. In one or more embodiments, soap system 1920 may include one or more storage tanks configured to store active agent 1912. In one or more embodiments, active agents may be poured and/or stored within storage tanks 1924 prior to use by system 1900. In one or more embodiments, storage tanks 1924 may include sensors 1928. In one or more embodiments, sensors 1928 may include any sensors a described in this disclosure. In one or more embodiments, sensors 1928 utilized for storage tanks may include level sensors, ultrasonic sensors and/or the like. In one or more embodiments, sensors 1928 may be used to identify a volumetric datum wherein a volumetric datum includes an amount of active agent within each storage tank. In one or more embodiments, soap system 1920 further includes a pump 1932. In one or more embodiments, pump 1932 may include any pump as described in this disclosure such as a peristaltic pump and/or a gear pump. In one or more embodiments, pump 1932 may be connected to storage tank by way of fluid connection such as through a hose and/or other piping that allows for a fluid to flow from storage tank 1924 as a result of pump 1932. In one or more embodiments, pump 1932 may pump active agent 1912 from storage tank 1924 and through soap tube 1936. In one or more embodiments, soap tube 1936 may include any piping and/or hosing that allows for fluid to flow from storage tank 1924 without leakage. In one or more embodiments, soap tube 1936 may be made of a pliable material such as soft plastic, silicone and/or the like. In one or more embodiments, a sensor 1928 may be located on the soap tube. In one or more embodiments, sensor 1928 on soap tube may include a pressure sensor configured to detect a pressure of active agent within soap tube 1936. In an embodiments, a buildup of pressure within soap tube 1936 may indicate that either pump 1932 is working too hard such that there is buildup, soap tube 1936 has been degraded and therefore flow rate has decreased and/or some other blockage down the line is causing a buildup of active agent 1912 within soap tube 1936 or that downstream backpressure on output has caused the venturi’s inlet pressure to reverse, eliminating the suction we expect during normal operation.

With continued reference to FIG. 19, dispensing system 1916 further includes a soap channel 1940. Soap channel 1940 includes any soap channel as described in this disclosure. In one or more embodiments, soap channel may be configured to route fluid 1904 through soap channel which may then be used to mix with active agent 1912. In one or more embodiments, an inlet of soap channel may include a water solenoid 1944. In one or more embodiments, water solenoid may include any solenoid 1944 as described in this disclosure. In one or more embodiments, fluid 1904 may be received from a city water line, a water tank connected to dispensing system 1916 and/or the like. In one or more embodiments, water solenoid may control a flow of fluid 1904 into dispensing system 1916. In one or more embodiments, water solenoid may be configured to provide a flow of fluid 1904 into dispensing system 1916. In one or more embodiments, a solenoid valve such as water solenoid 1944 may include an electromechanically operated valve. It may be controlled by an electric current (usually through a coil) which generates a magnetic field, causing the valve to open or close. In one or more embodiments, system 1900 may include a PH meter 1976. In one or more embodiments, PH meter 1976 may be configured to identify a PH of fluid 1904 prior to entry within soap channel. In one or more embodiments, information from PH meter may be transferred to a computing device, wherein the computing device (such as a controller as described in this disclosure) may be configured to identify a PH of the fluid and determine if the fluid is suitable for use. In an embodiment, a fluid containing a differing PH may interact negatively with active agent 1912.

With continued reference to FIG. 19, soap channel further includes a valve 1952. In one or more embodiments, valve 1952 may include any valve as described in this disclosure. In one or more embodiments, valve 1952 may be configured to control a flow or flow rate of fluid through soap channel 1940. In one or more embodiments, valve may be electromechanically operated, wherein valve 1952 may be operated through the use of commands transmitted by a controller 1972. In one or more embodiments, soap channel 1940 may contain a pressure sensor 1948 situated prior to valve and after water solenoid. In one or more embodiments, pressure sensor 1948 may monitor a pressure of fluid exiting water solenoid 1944 and entering valve 1952. In one or more embodiments, pressure sensor may be used to identify pressure drops from fluid entering through water solenoid. In one or more embodiments, fluid from valve 1952 may flow through soap channel 1940. In one or more embodiments, a flow meter 1956, such as any flow meter as described in this disclosure may be configured to monitor a flow rate or fluid after valve 1952. In one or more embodiments, a flow rate of fluid 1904 may decrease due to constrictions in flow rate placed by valve 1952. In one or more embodiments, flow meter 1956 may be used to ensure a proper flow rate through soap channel 1940.

With continued reference to FIG. 19, soap tube may be fluidly connected to soap channel 1940. In one or more embodiments, soap tube may be fluidly connected to soap channel such that active agent may flow from soap tube and into soap channel.

With continued reference to FIG. 19, soap channel 1940 further includes an injector system 1960. Injector system 1960 includes any injector system as described in this disclosure. In one or more embodiments, injector system 1960 may include a venturi valve configured to create a pressure differential that can be used to draw active agent from soap tube and into soap channel. A Venturi valve works by using the principles of fluid dynamics, specifically, the Venturi effect, to create a pressure differential that can be used to draw in active agent into a fluid stream of fluid 1904. Inside the Venturi valve is a specially shaped passage that narrows in the middle and then widens again, forming three sections: the inlet, the throat, and the outlet. As fluid 1904 enters the valve through the inlet, it flows into the throat, which is the narrowest part. Due to the constriction, the fluid velocity increases sharply in the throat, and as a result, the static pressure drops significantly in that area. Adjacent to this low-pressure zone is a suction port, where a secondary substance, such as active agent 1912 can be introduced. The drop in pressure at the throat creates a vacuum effect that pulls active agent into the main fluid flow within soap channel 1940. Once inside, the two fluids mix and continue through the expanding outlet section, where the flow slows down and pressure begins to recover. In one or more embodiments, fluid 1904 and active agent 1912 may combine to create mixture 1964 at an outlet of soap channel. In one or more embodiments, dispensing system 1916 may further include an air supply manifold 1968, wherein the air supply manifold is configured to supply air to the fluid and active agent combination in order to create mixture 1964 having air bubbles and/or foamy properties. In one or more embodiments, air supply manifold 1968 may allow for mixture to contain foamy properties and this allow for a better solution used to clean vehicles.

With continued reference to FIG. 19, system 1900 includes a controller 1972. Controller 1972 includes any controller as described in this disclosure. Controller 1972 may be configured to receive a datum from sensors 1928, pressure sensors, flow meters and/or the like in order to ensure that system 1900 is working properly. In one or more embodiments, controller may be configured to increase pressure of pump 1932 as a result of a decrease in active agent entering mixture 1964. In one or more embodiments, controller 1972 may receive flow rate of fluid within soap channel 1940 from flow meter and transmit commands to valve 1952 in order to adjust valve to increase or decrease flow rate. In one or more embodiments, controller may utilize sensor 1928 within soap tube and sensor 1928 within storage tank to identify the rate at which active agent is entering soap channel. This may be done by identifying a change in volume of storage tank using sensor and/or identifying a flow rate of soap using sensors within soap tube 1936. In one or more embodiments, controller 1972 may use a flow rate of active agent 1912 and a flow rate of fluid as identified by flow meter 1956 to identify a concentration of active agent within mixture 1964. In one or more embodiments, changes in concentration may indicate fluid buildup and/or issues with system 1900. In one or more embodiments, dispensing system 1916 may include a plurality of soap channels 1940 and a plurality of soap systems 1920, wherein each soap system 1920 may contain a correlated soap channel 1940. In one or more embodiments, dispensing system 1916 may contain a plurality of soap systems 1920, wherein each soap system may be configured for a differing active agent, such as for example, an active agent used for windows of a vehicle, an active agent used for cleaning tires, an active agent used for cleaning various portions of the car and/or the like. In one or more embodiments, controller may be configured to monitor each soap system 1920 and each soap channel 1940 in order to modify and/or adjust flow rates accordingly. In one or more embodiments, system 1900 and/or dispensing system 1916 may contain redundant components all connected to the same outlet. For example and without limitation, system 1900 may include more than one dispensing systems 1916, wherein the more than one dispensing systems 1916 may be used to ensure that mixture may flow in the event of a failure within a first dispensing system 1916. In one or more embodiments, each dispensing system 1916 may be connected to the same or similar outlet, such that mixture may be created within either dispensing system 1916 and reach the same location.

With continued reference to FIG. 19, controller 1972 may be configured to adjust flow rates of fluid and/or active agent in order to ensure proper concentration within mixture 1964. In one or more embodiments, controller 1972 may identify concentration of mixture by receiving a flow rate from flow meter 1956 and calculating flow rate of active agent using sensor within soap tube and/or sensor within storage tanks. In one or more embodiments, controller 1972 may adjust flow rates my increasing a power input of peristaltic pump and thus increasing a flow rate of active agent. In one or more embodiments, controller may identify a flow rate of active agent and increase or decrease power to peristaltic pump in order to adjust flow rate due to degradation of one or more components. In one or more embodiments, controller may further be configured to adjust valve, such that a flow rate of fluid may increase or decrease in order to maintain a desired dilution ration between active agent and fluid within mixture.

With continued reference to FIG. 19. Controller 1972 may be configured to identify tube degradation within system 1900. “Tube degradation” as described in this disclosure refers to the capability of an object to continue transfer fluids. For example, and without limitation, soap tube may be configured to navigate active agent to soap channel. However, if soap tube has become degraded, soap tube may lack the ability to continue to transport active agent at the desired flow rate under the same conditions. In one or more embodiments, controller 1972 may be configured to identify a tube degradation, wherein the tube degradation indicates the capability of a tube to transport a fluid such as fluid 1904 and/or active agent. In one or more embodiments, tube degradation may be measured in maximum flow rate, a percentage in comparison to an ideal tube and/or the like. In one or more embodiments, tube degradation may be measured in terms of pressure needed by peristaltic pump to increase flow rate. In one or more embodiments, tube degradation may be measured in terms of increased power output of one or more components of system 1900 needed in order to maintain the same or similar flow rate. For example, tube degradation may be measured at 120%, wherein an increase of 20% of power output may be needed to maintain the desired flow rate. In one or more embodiments, a pump may be operated by a stepper motor wherein RPM of the pump is a known valve. In one or more embodiments, controller 1972 may identify tube degradation by comparing an actual flow rate to an expected flow rate. An “actual flow rate” as described in this disclosure refers to a flow rate that has been calculated based on the use of one or more sensors. An expected flow rate for the purposes of this disclosure refers to a flow rate that is expected under the current power output conditions of system 1900. For example, and without limitation, actual flow rate may be determined by identifying flow rate of active agent 1912 through sensors 1928, by identifying flow rate of fluid through flow meter 1956 and/or by identifying flow rate of mixture using a sensor located at or near mixture. In another nonlimiting example, expected flow rate may include a flow rate that is calculated based on system 1900 working ideally. For example, expected flow rate may include a flow rate of 1 gallon per minute in instances in which no tube degradation occurs. In an embodiment, expected flow rate may include an initial flow rate identified by system 1900 on a previous day, month year and/or the like. In one or more embodiments, expected flow rate may be stored in a database and retrieved by controller. In one or more embodiments, controller 1972 may be configured to calculate actual flow rate by identifying a change in volume within storage tank and/or identifying a pressure within soap channel. In one or more embodiments, controller 1972 may compare actual flow rate to expected flow rate and transmit commands to peristaltic pump, water solenoid, valve and/or other electromechanical devices in order to increase power output and thus increase to decrease flow rate. In one or more embodiments, controller 1972 may identify tube degradation of system 1900 iteratively and adjust power output of various components accordingly.

With continued reference to FIG. 19, in one or more embodiments, a pump may be driven by a stepper motor, allowing precise control of rotational speed (RPM), which is a known and commanded parameter. Pump output may be directly proportional to RPM, assuming consistent mechanical and fluid conditions. Over time, the tubing connected to the pump may degrade due to chemical exposure or mechanical wear, leading to a reduction in the volume of fluid displaced per revolution. This degradation results in a lower actual flow rate for a given RPM. Actual Flow rate may then be determined by monitoring the change in tank level over time during dispensing. By measuring the volume dispensed, calculated from the rate of tank level change over a known time interval, the system can assess the real output of the pump. A calibration value, referred to as “pump trim,” may be periodically updated based on this observed flow rate. The pump trim value may be applied to the calculated nominal RPM to compensate for any discrepancy between expected and actual output. This adjustment ensures accurate dosing even as tubing characteristics change. The pump trim value may be maintained through ongoing calibration and is updated continuously throughout operation. When tubing is replaced, restoring original flow characteristics, the pump trim value is reset to a nominal baseline.

With continued reference to FIG. 19, in one or more embodiments, controller 1972 may be configured to store actual and expected flow rates on database. In one or more embodiments, controller 1972 may be configured to identify a change in tube degradation over time by plotting actual and expected flow rates over time. In one or more embodiments, controller may be configured to predict tube degradation and/or change in tube degradation over time by identifying trends in changes to expected and actual flow rates. Similarly, controller may be configured to identify component degradation wherein component degradation includes the ability of a component of system 1900 to work properly. In one or more embodiments, component degradation may include identification of a valve that does not work properly, identification of injection device not working properly and/or beginning to degrade. In one or more embodiments, controller 1972 may be configured to modify power output to one or more components of system in order to adjust for component degradation. In one or more embodiments, controller 1972 may be configured to predict degradation of components by identifying trends in actual vs expected flow rates. In one or more embodiments, controller 1972 may be configured to notify a user such as through a remote device, when a component has degraded and/or when a component is expected to require replacement due to degradation. In one or more embodiments, changes in environmental pressure, temperature and/or the like may affect flow rates. In one or more embodiments, controller 1972 may be configured to identify expected vs actual flow rates and adjust accordingly due to changes in the surrounding environment. For example, and without limitation, on a hotter day, actual flow rates may differ. In one or more embodiments, controller may use linear models and/or machine learning model to calculate and/or predict component degradation and/or tube degradation. In one or more embodiments, a surrounding environment of system 1900 may affect flow rates and/or dilution ratios. In one or more embodiments, factors affecting dilution ratios may include changes in humidity, changes in temperature, changes in PH of the fluid entering system, changes in chemicals within fluid entering system and/or the like. In one or more embodiments, controller may identify changes in flow rate that may emanate from environmental factors, wherein controller may adjust peristaltic pump and/or valve to ensure a desired dilution ratio between active agent and fluid. In one or more embodiments, controller may be configured to identify tube life estimation, wherein tube life estimation includes an indication on how long a tube can be used until it required replacement. In one or more embodiments, controller 1972 may use changes in tube degradation to calculate tube life estimation.

With continued reference to FIG. 19, soap system 1920 and/or storage tank 1924 may be configured to store active agents, such as active agents utilized for washing bugs off of vehicles. In one or more embodiments, active agent 1912 may include a bug remover pre-treatment for a vehicle. In one or more embodiments, the bug remover pre-treatment may include on or more chemicals designed to break down and loosen the proteins, sugars, and acids in bug splatter so they can be rinsed away more easily. In one or more embodiments, the pre-treatment may include alkaline surfactants, to break down organic matter such as bugs and tree sap. In one or more embodiments, the pre-treatment may include citrus-based solvents, used to cleaning as well. In one or more embodiments, the pre-treatment may further include enzymatic cleaners used to help digest organic matter. In one or more embodiments, soap system 1920 may be configured to store active agent 1912 such as pre-treatment in order to utilize active agent 1912 for cleaning a vehicle. In one or more embodiments, active agent 1912 may be diluted with fluid, such as water 1908 and navigated downstream to a car washing device. In one or more embodiments, the car washing device may include pumps, tubing and/or the like configured to expel the mixture 1964 at a high pressure.

With continued reference to FIG. 19, in one or mor embodiments, system 1900 may be activated and/or deactivated through the use of external devices. An “external device” for the purposes of this disclosure is a device separate from system 1900 that is configured to communicate with system 1900. For example, and without limitation, external device may include a remote device, such as a smart phone, wherein the smart phone maybe configured to initiate system 1900 and allow for active agent 1912 to be pumped through system and thus mixture 1964 is created. In one or more embodiments, external device may include pressure sensors within a car wash tunnel, wherein engagement of the pressure sensors by a vehicle, may indicate to system 1900 to initiate pumps, water manifolds, and/or the like in order to create mixture 1964 and navigate mixture 1964 through system 1900 and into car wash tunnel onto vehicle. In one or more embodiments, external device may include ultrasonic sensors, pressure sensors and/or any other sensors configured to identify the presence of a vehicle. In one or more embodiments, external devices may be used to initiate system 1900 and communicate with controller to initiate generation of mixture 1964.

With continued reference to FIG. 19, in one or more embodiments, aspects of the present disclosure may allow for dilution adjustment. Dilution adjustment is achieved through digital control of water and chemical flow rates using a remote device communicatively connected to controller 1972. Controller may receive input from a user via a graphical user interface (GUI). The GUI may be presented on a remote device, such as a smart phone, laptop and/or the like. In one or more embodiments, the GUI may present interactive sliders that correspond to dilution ratio settings. These inputs may be transmitted wirelessly or via a local network (e.g., Wi-Fi, Ethernet) to controller. The controller then adjusts either digital proportional valves or pump speeds, depending on the hardware configuration, to alter water and soap flow rates entering a venturi or mixing chamber. The adjustments may be performed in real time while the operator observes the output directly in the wash tunnel, enabling immediate response to desired changes in mixture characteristics. The GUI may be developed using common web-based frameworks and served from an embedded HTTP server within the control unit.

With continued reference to FIG. 19, system 1900 may include a tank level sensor, typically an ultrasonic, capacitive, or float-type sensor, installed in the soap reservoir within storage tank. This sensor may continuously report the fluid level to controller. Expected consumption rate is calculated based on known operational parameters such as pump RPM, commanded duty cycles, and dispensing intervals. Controller may compare the real-time rate of level depletion against the calculated expected rate over fixed time windows. If the observed depletion rate significantly exceeds the expected rate, controller may flag a discrepancy indicating a possible major leak. This function may use a time-weighted moving average algorithm or threshold-based logic to avoid false positives from minor variations. Leak detection logic runs continuously and logs data to support diagnostics.

With continued reference to FIG. 19, coil current monitoring may be implemented by integrating current-sensing circuitry into the power lines supplying solenoid valves and stepper motor drivers. This may be typically done using Hall-effect current sensors, low-resistance current shunt monitors, or integrated motor driver feedback signals. The current draw may be sampled at a fixed frequency by an analog-to-digital converter and processed by controller 1972 to identify electrical characteristics such as normal energizing current, open coil (zero current when commanded on), or short circuit (excessive current). For stepper motors, this monitoring can also reveal mechanical stalling, cable faults, or partial winding failures. Current profiles may be stored and compared against known operational baselines, and any deviations outside pre-defined bounds can trigger diagnostics or alerts.

With continued reference to FIG. 19, a diagnostic system may operate on controller 1972 wherein the diagnostic system continuously collects data from sensors (e.g., pressure sensors, flow sensors), electrical inputs (e.g., valve states, motor currents), and logic conditions (e.g., command status vs. sensor feedback). It executes rule-based logic trees or conditional decision trees where individual fault criteria are evaluated in real time. For example, if outlet pressure sensors report values exceeding 20 psi while the water valve control signal is off and the valve coil current is measured at zero, the system infers a mechanical failure in the valve (stuck open). Each diagnostic rule has a unique identifier that corresponds to a fault code. These fault codes are logged, timestamped, and optionally displayed via a user interface or exported to maintenance systems. Diagnostic rules are defined using condition sets with logical operators and can be updated via firmware.

With continued reference to FIG. 19, Quick-disconnect fittings may be implemented using standardized push-to-connect or twist-lock connectors placed at critical junctions in a dilution channel, soap channel and/or designated channel fluid pathway. These fittings allow for tool-less disconnection and reconnection of tubing, simplifying maintenance tasks such as tubing replacement, venturi cleaning, or chemical flushing. Material selection for these fittings must consider chemical compatibility (e.g., using EPDM, Viton, or polypropylene) and pressure rating consistent with the system’s operating parameters. Fittings may also be installed with locking clips or retention mechanisms to prevent accidental disconnection under pressurized conditions. Integration of flow shutoff valves directly into the fittings is also possible, allowing automatic sealing of lines when disconnected.

With continued reference to FIG. 19, in one or more embodiments, a positive displacement gear pump may replace the peristaltic pump, delivering chemicals and/or active agents at a regulated high pressure of approximately 75 psi. This pressure is sufficient to overcome backpressure and to inject the chemical directly into a pressurized water line without relying on venturi suction. The mixing point consists of a T junction where water and chemical converge. A check valve is installed on the chemical line at the T junction to prevent backflow into the gear pump when water pressure exceeds chemical line pressure. Flow regulation is controlled by the gear pump speed, set via a variable-frequency drive or electronically controlled motor. This configuration simplifies the fluid circuit and enables high-precision dosing by directly metering chemical volume per pump revolution, leveraging the consistent output characteristics of gear pumps.

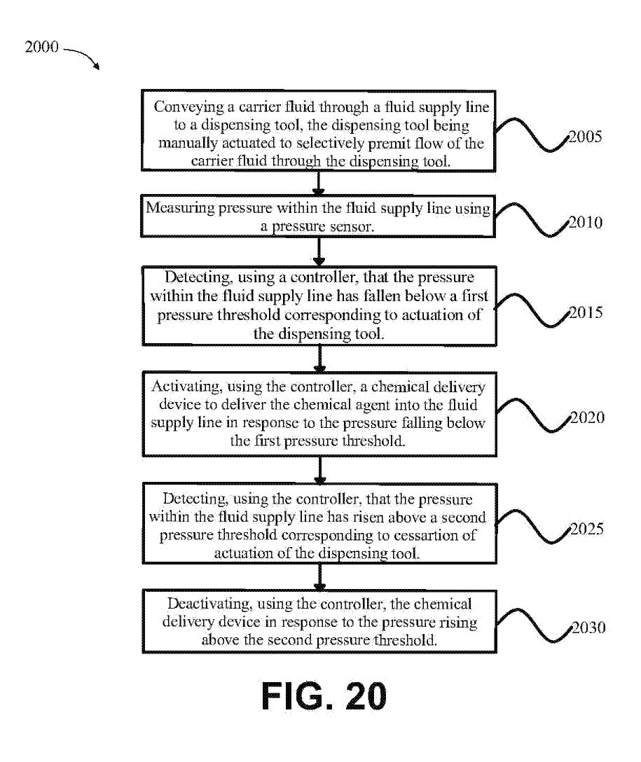

Now referring to FIG. 20, a flow diagram of an exemplary method 2000 for dispensing a chemical agent is illustrated. Method 2000 may include a step 2005 of conveying a carrier fluid through a fluid supply line to a dispensing tool, the dispensing tool being manually actuated to selectively permit flow of the carrier fluid through the dispensing tool. This may be implemented, without limitation, as referenced and discussed in FIGS. 1-19.

In continued reference to FIG. 20, method 20 may include a step 2010 of measuring pressure within the fluid supply line using a pressure sensor. In an embodiment, the pressure sensor is disposed along the fluid supply line upstream of the dispensing tool. This may be implemented, without limitation, as referenced and discussed in FIGS. 1-19.

With further reference to FIG. 20, method 2000 may include a step 2015 of detecting, using a controller, that the pressure within the fluid supply line has fallen below a first pressure threshold corresponding to actuation of the dispensing tool. This may be implemented, without limitation, as referenced and discussed in FIGS. 1-19.

Still referring to FIG. 20, method 2000 may include a step 2020 of activating, using the controller, a chemical delivery device to deliver the chemical agent into the fluid supply line in response to the pressure falling below the first pressure threshold. In an embodiment, the chemical delivery device may include a peristaltic pump. In an embodiment, the chemical delivery device may supply the chemical agent to a venturi injector disposed along the fluid supply line. This may be implemented, without limitation, as referenced and discussed in FIGS. 1-19.

With continued reference to FIG. 20, method 2000 may include a step 2025 of detecting, using the controller, that the pressure within the fluid supply line has risen above a second pressure threshold corresponding to cessation of actuation of the dispensing tool. This may be implemented, without limitation, as referenced and discussed in FIGS. 1-19.

In further reference to FIG. 20, method 2000 may include a step 2030 of deactivating, using the controller, the chemical delivery device in response to the pressure rising above the second pressure threshold. This may be implemented, without limitation, as referenced and discussed in FIGS. 1-19.

Still referring to FIG. 20, method 20 may include opening a valve disposed along the fluid supply line upstream of the dispensing tool to permit the carrier fluid to flow through the fluid supply line when the pressure within the fluid supply line falls below the first pressure threshold and closing the valve to restrict flow of the carrier fluid when the pressure within the fluid supply line exceeds the second pressure threshold. In an embodiment, the valve may include a solenoid valve controlled by the controller. This may be implemented, without limitation, as referenced and discussed in FIGS. 1-19.

In continued reference to FIG. 20, method 2000 may include maintaining, using the controller, a standby pressure within the fluid supply line when the dispensing tool is not manually actuated by selectively actuating a valve disposed along the fluid supply line to maintain the pressure at or above the first pressure threshold. This may be implemented, without limitation, as referenced and discussed in FIGS. 1-19.

With further reference to FIG. 20, the first pressure threshold and the second pressure threshold may define a hysteresis band configured to prevent rapid cycling of the chemical delivery device. In an embodiment, the first pressure threshold may be approximately 80 PSI and the second pressure threshold is approximately 100 PSI. This may be implemented, without limitation, as referenced and discussed in FIGS. 1-19.

Still referring to FIG. 20, method 2000 may include activating, using the controller, the chemical delivery device after the pressure within the fluid supply line rises to or above the first pressure threshold following manual actuation of the dispensing tool. This may be implemented, without limitation, as referenced and discussed in FIGS. 1-19.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 21 shows a diagrammatic representation of one embodiment of a computing device in the exemplary form of a computer system 2100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 2100 includes a processor 2104 and a memory 2108 that communicate with each other, and with other components, via a bus 2112. Bus 2112 may include any of several types of bus structures including, but not limited to, a memory bus, a memory controller, a peripheral bus, a local bus, and any combinations thereof, using any of a variety of bus architectures.

Processor 2104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 2104 may be organized according to Von Neumann and/or Harvard architecture as a non-limiting example. Processor 2104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 2108 may include various components (e.g., machine-readable media) including, but not limited to, a random-access memory component, a read only component, and any combinations thereof. In one example, a basic input/output system 2116 (BIOS), including basic routines that help to transfer information between elements within computer system 2100, such as during start-up, may be stored in memory 2108. Memory 2108 may also include (e.g., stored on one or more machine-readable media) instructions (e.g., software) 2120 embodying any one or more of the aspects and/or methodologies of the present disclosure. In another example, memory 2108 may further include any number of program modules including, but not limited to, an operating system, one or more application programs, other program modules, program data, and any combinations thereof. Memory 2108 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 2100 may also include a storage device 2124. Examples of a storage device (e.g., storage device 2124) include, but are not limited to, a hard disk drive, a magnetic disk drive, an optical disc drive in combination with an optical medium, a solid-state memory device, and any combinations thereof. Storage device 2124 may be connected to bus 2112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 2124 (or one or more components thereof) may be removably interfaced with computer system 2100 (e.g., via an external port connector (not shown)). Particularly, storage device 2124 and an associated machine-readable medium 2128 may provide nonvolatile and/or volatile storage of machine-readable instructions, data structures, program modules, and/or other data for computer system 2100. In some embodiments, storage device 2124 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 2120 may reside, completely or partially, within machine-readable medium 2128. In another example, software 2120 may reside, completely or partially, within processor 2104.

Computer system 2100 may also include an input device 2132. In one example, a user of computer system 2100 may enter commands and/or other information into computer system 2100 via input device 2132. Examples of an input device 2132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 2132 may be interfaced to bus 2112 via any of a variety of interfaces (not shown) including, but not limited to, a serial interface, a parallel interface, a game port, a USB interface, a FIREWIRE interface, a direct interface to bus 2112, and any combinations thereof. Input device 2132 may include a touch screen interface that may be a part of or separate from display 2136, discussed further below. Input device 2132 may be utilized as a user selection device for selecting one or more graphical representations in a graphical interface as described above.

A user may also input commands and/or other information to computer system 2100 via storage device 2124 (e.g., a removable disk drive, a flash drive, etc.) and/or network interface device 2140. A network interface device, such as network interface device 2140, may be utilized for connecting computer system 2100 to one or more of a variety of networks, such as network 2144, and one or more remote devices 2148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 2144, may employ a wired and/or a wireless mode of communication. In general, any network topology may be used. Information (e.g., data, software 2120, etc.) may be communicated to and/or from computer system 2100 via network interface device 2140.

Computer system 2100 may further include a video display adapter 2152 for communicating a displayable image to a display device, such as display 2136. Examples of a display device include, but are not limited to, a liquid crystal display (LCD), a cathode ray tube (CRT), a plasma display, a light emitting diode (LED) display, and any combinations thereof. Display adapter 2152 and display 2136 may be utilized in combination with processor 2104 to provide graphical representations of aspects of the present disclosure. In addition to a display device, computer system 2100 may include one or more other peripheral output devices including, but not limited to, an audio speaker, a printer, and any combinations thereof. Such peripheral output devices may be connected to bus 2112 via a peripheral interface 2156. Examples of a peripheral interface include, but are not limited to, a serial port, a USB connection, a FIREWIRE connection, a parallel connection, and any combinations thereof.

Further referring to FIG. 21, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 21, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 21, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 2100, processor 2104, and memory 2108 may be virtualized; that is, a virtual machine and/or container may interact directly with such computing system 2100, processor 2104, and/or memory 2108, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 2104 comprises a plurality of processors and/or processor cores, virtualization may, in some cases, simulate or emulate a single (virtual) processor whose functions are allocated to one or more of the plurality of processors and/or processor cores. In this case, while processor 2104 may be said to be virtualized, the processor 2104, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A chemical dispensing system, the system comprising:
a fluid supply line configured to convey a carrier fluid to a dispensing tool;
the dispensing tool configured to be manually actuated to selectively permit flow of the carrier fluid through the dispensing tool;
a chemical delivery device configured to deliver a chemical agent into the fluid supply line;
a pressure sensor configured to measure pressure within the fluid supply line; and
a controller communicatively connected to the pressure sensor and the chemical delivery device, wherein the controller is configured to:
detect that the pressure within the fluid supply line has fallen below a first pressure threshold corresponding to actuation of the dispensing tool;
activate the chemical delivery device in response to the pressure falling below the first pressure threshold;
detect that the pressure within the fluid supply line has risen above a second pressure threshold corresponding to cessation of actuation of the dispensing tool; and
deactivate the chemical delivery device in response to the pressure rising above the second pressure threshold.

2. The system of claim 1, wherein the chemical delivery device comprises a peristaltic pump.

3. The system of claim 1, wherein the chemical delivery device supplies the chemical agent to a venturi injector disposed along the fluid supply line.

4. The system of claim 1, wherein the pressure sensor is disposed along the fluid supply line upstream of the dispensing tool.

5. The system of claim 1, wherein the system further comprises a valve disposed along the fluid supply line upstream of the dispensing tool, wherein the valve is configured to:
open to permit the carrier fluid to flow through the fluid supply line when the pressure within the fluid supply line falls below the first pressure threshold; and
close to restrict flow of the carrier fluid when the pressure within the fluid supply line exceeds the second pressure threshold.

6. The system of claim 5, wherein the valve comprises a solenoid valve controlled by the controller.

7. The system of claim 1, wherein the controller is further configured to maintain a standby pressure within the fluid supply line when the dispensing tool is not manually actuated by selectively actuating a valve disposed along the fluid supply line to maintain the pressure at or above the first pressure threshold.

8. The system of claim 1, wherein the first pressure threshold and the second pressure threshold define a hysteresis band configured to prevent rapid cycling of the chemical delivery device.

9. The system of claim 1, wherein:
the first pressure threshold is approximately 80 PSI; and
the second pressure threshold is approximately 100 PSI.

10. The system of claim 1, wherein the controller is configured to activate the chemical delivery device after the pressure within the fluid supply line rises to or above the first pressure threshold following manual actuation of the dispensing tool.

11. A method of dispensing a chemical agent, the method comprising:
conveying a carrier fluid through a fluid supply line to a dispensing tool, the dispensing tool being manually actuated to selectively permit flow of the carrier fluid through the dispensing tool;
measuring pressure within the fluid supply line using a pressure sensor;
detecting, using a controller, that the pressure within the fluid supply line has fallen below a first pressure threshold corresponding to actuation of the dispensing tool;
activating, using the controller, a chemical delivery device to deliver the chemical agent into the fluid supply line in response to the pressure falling below the first pressure threshold;
detecting, using the controller, that the pressure within the fluid supply line has risen above a second pressure threshold corresponding to cessation of actuation of the dispensing tool; and
deactivating, using the controller, the chemical delivery device in response to the pressure rising above the second pressure threshold.

12. The method of claim 11, wherein the chemical delivery device comprises a peristaltic pump.

13. The method of claim 11, wherein the chemical delivery device supplies the chemical agent to a venturi injector disposed along the fluid supply line.

14. The method of claim 11, wherein the pressure sensor is disposed along the fluid supply line upstream of the dispensing tool.

15. The method of claim 11, further comprising:
opening a valve disposed along the fluid supply line upstream of the dispensing tool to permit the carrier fluid to flow through the fluid supply line when the pressure within the fluid supply line falls below the first pressure threshold; and
closing the valve to restrict flow of the carrier fluid when the pressure within the fluid supply line exceeds the second pressure threshold.

16. The method of claim 15, wherein the valve comprises a solenoid valve controlled by the controller.

17. The method of claim 11, further comprising maintaining, using the controller, a standby pressure within the fluid supply line when the dispensing tool is not manually actuated by selectively actuating a valve disposed along the fluid supply line to maintain the pressure at or above the first pressure threshold.

18. The method of claim 11, wherein the first pressure threshold and the second pressure threshold define a hysteresis band configured to prevent rapid cycling of the chemical delivery device.

19. The method of claim 11, wherein:
the first pressure threshold is approximately 80 PSI; and
the second pressure threshold is approximately 100 PSI.

20. The method of claim 11, further comprising activating, using the controller, the chemical delivery device after the pressure within the fluid supply line rises to or above the first pressure threshold following manual actuation of the dispensing tool.
